(19) United States
(12) Patent Application Publication
(10) Pub. No.: US 2026/0074758 A1
(43) Pub. Date: Mar. 12, 2026

(54) METHOD FOR TIME DOMAIN CHANNEL PROPERTIES REPORTING

(71) Applicant: InterDigital Patent Holdings, Inc., Wilmington, DE (US)

(72) Inventors: Mohammad Irfan, Chateauguay (CA); Loic Canonne-Velasquez, Dorval (CA); Afshin Haghighat, Ile-Bizard (CA); Moon IL Lee, Melville, NY (US); Jonghyun Park, Syosset, NY (US); Dylan Watts, Montreal (CA)

(73) Assignee: InterDigital Patent Holdings, Inc., Wilmington, DE (US)

(21) Appl. No.: 19/108,389

(22) PCT Filed: Sep. 15, 2023
(86) PCT No.: PCT/US2023/074362

§ 371 Date: Mar. 3, 2025

Related U.S. Application Data
(60) Provisional application No. 63/410,851, filed on Sep. 28, 2022.
(60) Provisional application No. 63/421,441, filed on Nov. 1, 2022.
(60) Provisional application No. 63/444,606, filed on Feb. 10, 2023.
(60) Provisional application No. 63/456,280, filed on Mar. 31, 2023.

(51) Int. Cl. H04B 7/06; H04B 17/364

(52) U.S. Cl. CPC H04B 7/0626; H04B 17/364

(57) ABSTRACT

A wireless transmit/receive unit (WTRU) may receive a downlink (DL) reference signal on a DL channel. The WTRU may measure a Doppler related parameter value based on the DL reference signal. The WTRU may estimate one or more time domain channel properties (TDCPs) of the DL channel associated with one or more delays. The one or more TDCPs may be based on the measured Doppler related parameter value. The WTRU may determine a confidence level for the one or more estimated TDCPs based on one or more of channel conditions, WTRU architecture, receive antenna configuration information, channel state information (CSI) reporting configuration, and/or system configuration. The WTRU may send a report that indicates the one or more estimated TDCPs and the confidence level for the one or more estimated TDCPs.

### CROSS-REFERENCE TO RELATED APPLICATIONS

This application claims priority to U.S. Provisional Patent Application No. 63/410,851, filed Sep. 28, 2022; U.S. Provisional Patent Application No. 63/421,441, filed Nov. 1, 2022; U.S. Provisional Patent Application No. 63/444,606, filed Feb. 10, 2023; and U.S. Provisional Patent Application No. 63/456,280, filed Mar. 31, 2023, the entire contents of which are incorporated herein by reference in their entirety.

### BACKGROUND

Reporting channel state information (CSI) is already an expensive process in terms of feedback overhead and complexity. CSI overhead and the related reporting complexity increases with increasing channel variations. Rel-18 aims at enhancing Type-II CSI reporting when a wireless transmit/receive unit (WTRU) is travelling with a medium to high velocity. Particularly, Rel-18 aims at studying time and Doppler domain (DD) information to assist downlink precoding in high Doppler scenarios.

### SUMMARY

The examples herein may provide less complex and low overhead procedures for multiple reporting of W_2's for fixed W_1 and W_f in the presence of medium to high Doppler. The examples described herein may provide procedures for Doppler-domain compression of W_2 in the presence of medium to high Doppler. The examples described herein may provide procedures for channel and/or W_2 prediction quality reporting in the presence of medium to high Doppler. Further, the examples described herein may provide procedures for reporting Type-II pre-coding matrix indicator (PMI) reporting in high Doppler scenarios.

A method for reporting Type-II channel state information (CSI) may include observing Doppler domain information. The method may include fixing the spatial domain base of a Type-II precoder matrix. The method may include fixing the frequency domain base of a Type-II precoder matrix. The method may include identifying the co-phasing coefficients of a Type-II precoder matrix. The method may include identifying one or more CSI report(s), wherein the identified one or more CSI report(s) depends on the observed Doppler domain information. The method may include identifying one or more component precoder(s), wherein the identified precoder(s) depends on the observed Doppler domain information. The method may include sending to the network the identified co-phasing coefficients, CSI report(s), and component precoders. The method may include identifying the co-phasing coefficients of a Type-II precoder matrix may include one or more non-zero coefficients and/or a strongest coefficient. The method may include identifying a report about the time variations of the channel.

A wireless transmit/receive unit (WTRU) may receive a downlink (DL) reference signal on a DL channel. The WTRU may measure a Doppler related parameter value based on the DL reference signal. The WTRU may estimate one or more time domain channel properties (TDCPs) of the DL channel associated with one or more delays. The one or more TDCPs may be based on the measured Doppler related parameter value. The WTRU may determine a confidence level for the one or more estimated TDCPs based on one or more of channel conditions, WTRU architecture, receive antenna configuration information, channel state information (CSI) reporting configuration, and/or system configuration. The WTRU may send a report that indicates the one or more estimated TDCPs and the confidence level for the one or more estimated TDCPs.

The WTRU may determine whether the confidence level (CL) is below a pre-configured threshold.

The report may indicate a null value for the one or more estimated TDCPs when the CL is below the pre-configured threshold. The TDCP may be a non-quantized TDCP. The WTRU may be further configured to quantize the non-quantized TDCP. The CL may be determined by comparing the estimated TDCP with a measured TDCP. The one or more delays may comprise a maximum delay that satisfies a preconfigured time threshold. The report may be a CSI report. The CSI report may be transmitted with a higher priority as compared to other CSI reports.

The Doppler related parameter value may be one of a Doppler shift, a Doppler spread, and/or a time domain channel correlation. The TDCP may be one or more of a Doppler shift, a Doppler spread, and/or a time domain channel correlation. The WTRU may assign one an amplitude value and/or a phase value to the one or more estimated TDCPs.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment; and

FIG. 1D is a system diagram illustrating a further example RAN and a further example CN that may be used within the communications system illustrated in FIG. 1A according to an embodiment.

FIG. 2 illustrates an example grid of different quantization resolutions for different beams/polarizations and DFT vector indexes.

### DETAILED DESCRIPTION

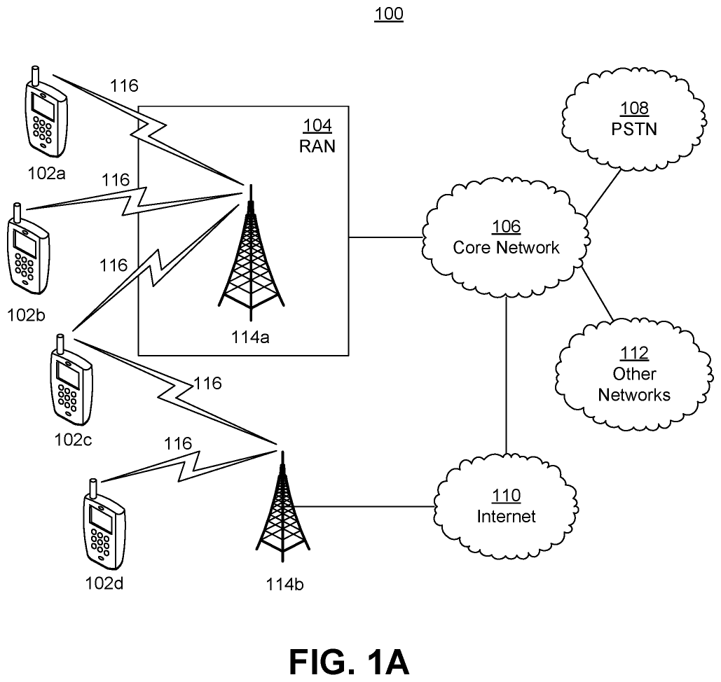

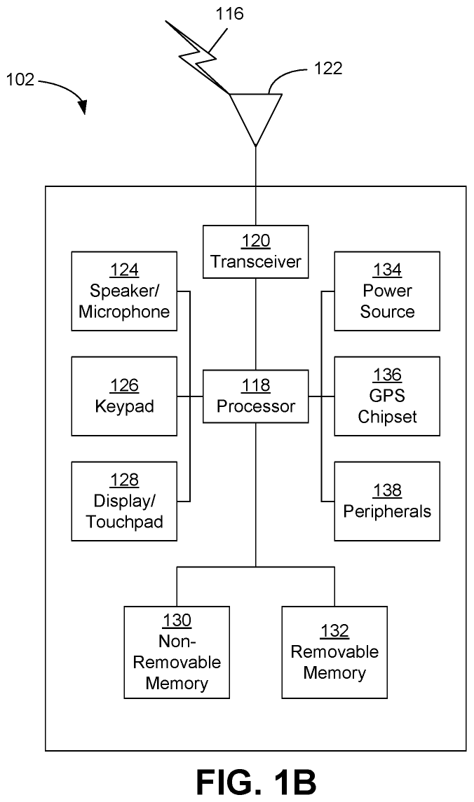

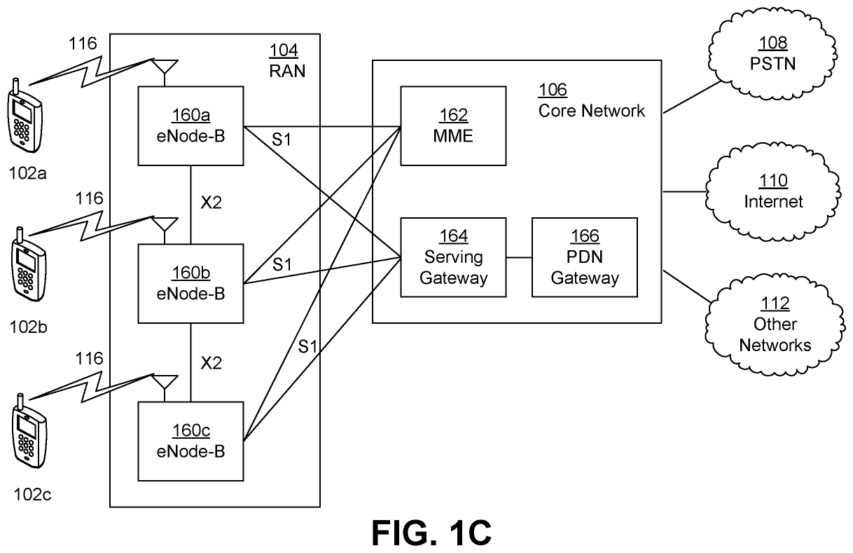

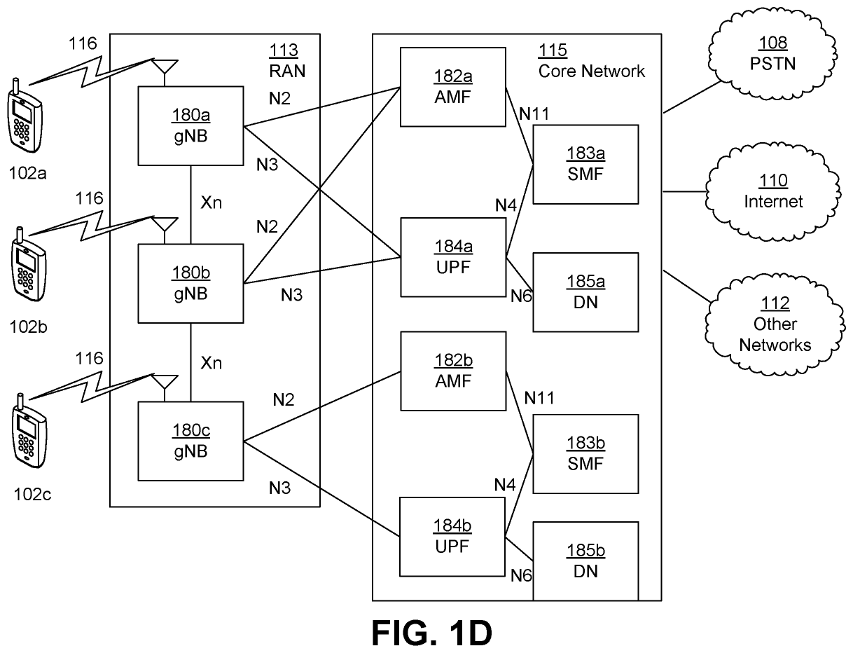

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility management function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session management function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

One or more examples provided herein may reduce feedback overhead when reporting Type-II channel state information (CSI) in high Doppler scenarios. A Type-II precoder in matrix form may be expressed as W=W₁W₂W_{f}^{H}, where W₁ (e.g., which may be represented as W_1) is the matrix of spatial domain (SD) bases selection, W₂ (e.g., which may be represented as W_2) are the co-phasing coefficients, and W_{f}^{H} is (e.g., which may be represented as W_f or W_f\hat{ }H) the frequency domain (FD) bases selection. In a high Doppler scenario, the SD and/or FD bases (e.g., W₁ and/or W_{f}) may remain constant over longer periods as compared to the co-phasing coefficients W₂. The majority of the overhead in a Type-II CSI report may be generated by W₂. One or more of the examples provided herein may provide for the reporting of W₂ with smaller feedback overhead, for instance, in a high Doppler scenario. A high-level overview of a plurality of examples that may be used to address the feedback overhead issue in high Doppler scenarios are disclosed herein.

A WTRU may report multiple co-phasing coefficient matrices W₂ for fixed SD bases W₁ and/or FD bases W_{f} based on the existing Rel. 16/17 Type-II CSI framework. A WTRU may use Doppler-domain compression on top of the frequency domain compression (e.g., in the Rel. 16/17 Type-II codebooks), for example, to further compress the co-phasing coefficients matrices W₂s. The WTRU may be configured to predict the channel and/or the co-phasing coefficient matrix W₂ for future time instances, for example, to address the issue of CSI aging in high Doppler scenarios.

The examples herein may provide: less complex and low overhead procedures for multiple reporting of W_2's for fixed W_1 and W_f in the presence of medium to high Doppler; procedures for Doppler-domain compression of W_2 in the presence of medium to high Doppler; procedures for channel and/or W_2 prediction quality reporting in the presence of medium to high Doppler; and/or detail on CSI omission and/or prioritization in the presence of medium to high Doppler. The examples described herein may describe: switching between legacy, multiple reporting of W_2 with fixed W_1 and/or W_f, and/or Doppler domain compression; detail time domain channel properties reporting; and/or procedures for reporting Type-II pre-coding matrix indicator (PMI) reporting in high Doppler scenarios.

New Radio (NR) Rel-16/17 Type-II CSI framework may be based on several sub-functionalities that encompass wideband and/or narrow band CSI, beam combining, co-phasing and/or frequency-domain compression. The Rel-16/17 CSI may rely on instantaneous CSI. The Rel-16/17 CSI may assume that the wireless channel does not experience a significant change between CSI measurement instances. This is not a valid assumption in the context of Rel. 18 high Doppler scenario, where the channel changes at a high rate. In a high Doppler scenario, CSI reporting based on the existing Rel. 16/17 CSI framework may result in significant feedback overhead.

The Rel. 16/17 Type-II precoder in matrix form may be written as W_1, W_2, W_f\hat{ }H (e.g., W=W₁W₂W_{f}^{H}). The SD selection bases W_1 and FD selection bases W_f of a Type-II precoder may remain constant for longer durations. Therefore, frequent reporting of W_1 and W_f of a Type-II PMI may not be needed, which can result in overhead reduction. In a Type-II CSI report, most of the overhead may be generated by the co-phasing coefficients W_2. W_2 may change at a much faster rate as compared to W_1 and W_f in a high Doppler scenario. Therefore, a WTRU may report multiple W_2's for a fixed number of W_1 and W_f (e.g., in high Doppler scenarios).

When reporting multiple W_2's for fixed W_1 and W_f, Type-II component precoders may be defined. For example, different Type-II component precoders may be expressed as PMI_1=W_1; PMI_2=W_2; PMI_3=W_f; PMI_4=W_1, W_2; PMI_5=W_1, W_f; and/or PMI_6=W_2, W_f.

Hereinafter, SD bases W_1 may be used interchangeably with the above-mentioned component precoders PMI_1/4/5, and FD bases W_f may be used interchangeably used with component precoders PMI_3/5/6. Similarly, co-phasing coefficients matrix W_2 may be used interchangeably with component precoders PMI_2/4/6. Moreover, the term Doppler may be used as an alternative for Doppler shift, Doppler spread, Doppler frequency, average Doppler shift, average Doppler spread, average Doppler frequency, maximum Doppler shift, relative Doppler shift, correlation within RS resources, correlation within one tracking reference signal (TRS) resource, and/or correlation within multiple TRS resources, etc. Doppler related parameter value may be a Doppler shift, a Doppler spread, a Doppler frequency, an average Doppler shift, an average Doppler spread, an average Doppler frequency, a maximum Doppler shift, a relative Doppler shift, a correlation within RS resources, a correlation within one tracking reference signal (TRS) resource, correlation within multiple TRS resources, and/or other time domain channel correlation, etc. In a high Doppler scenario, a WTRU may report N component precoders (e.g., PMI_2) for one or more component precoders (e.g., PMI_1/3/4/5/6). Hereinafter, N may be interchangeably used with the number of slots in a CSI measurement window and/or the length of Doppler domain bases.

Component precoders reporting using multiple CSI reports may include linkage of component precorders to fixed W_1 and/or W_f. A WTRU may report multiple component precoders for fixed W_1 and W_f. With the report, the gNB may need to know the number of component precoders N, indices of the CSI reports carrying N component precoders for fixed W_1 and W_f, number of CSI reports carrying N component precoders, the number of component precoders per CSI report, and/or the type of component precoders.

Based on the observed Doppler, a WTRU may determine N, a number of CSI reports carrying N component precoders, indices of the CSI reports carrying the N component precoders, an index of the first CSI report and/or last CSI report carrying N component precoders, a number of component precoders in each CSI report, and/or the type of component precoders (e.g., PMI_1/2/3/4/5/6). The WTRU may make this determination for a fixed W_1 and/or W_f, for example. In examples, a WTRU may use different thresholds of Doppler to obtain different values of N.

A WTRU may report an indication of N in a CSI report carrying legacy PMI and/or a CSI report carrying SD bases W_1 and/or FD bases W_f. A WTRU may include an indication for the indices of the CSI reports carrying N component precoders in a CSI report which reports legacy PMI and/or a CSI report which report SD bases W_1 and/or FD bases W_f. A WTRU may include an indication for the number of components precoders in the CSI report, for example, for each CSI report carrying component precoders.

A WTRU may report N component precoders using multiple CSI reports on different physical uplink control channel (PUCCH) and/or physical uplink shared channel (PUSCH) resources; the number of CSI reports reported on PUCCH; the number of CSI reports reported on PUSCH (which may be linked to, e.g., fixed W_1 and W_f); and/or indices of the CSI reports carrying component precoders on PUCCH and/or PUSCH linked to W_1 and/or W_f.

Regarding number of non-zero coefficients (NNZCs), in a Rel. 16/17 Type-II CSI report, a WTRU may report the NNZC's in W_2 in a high reporting priority portion of the CSI report, commonly known as part 1 of the CSI report. When reporting multiple W_2s for fixed W_1 and W_f, a WTRU may report the NNZC's for each W_2 matrix. The NNZCs may be different or the same for each W_2 matrix.

In some examples, a WTRU may not report indications of the NNZC's in part 1 of a CSI report, for example, for each W_2 or component precoders PMI_2/4/6. The WTRU may include (e.g., only include) in part 1 of the CSI report a channel quality indicator (CQI), a rank indicator (RI) and/or an indicator for layer, beam/polarization, discrete Fourier transform (DFT) vector indices, and/or Doppler domain bases indices of non-zero coefficients. The indicator may report layer, beam/polarization, and/or DFT vector indices and/or Doppler domain bases indices of all NZC's or the high priority NZC's. The gNB may estimate the NNZCs by observing the indices of the NZCs. Details pertaining to the layer, beam/polarization and/or DFT vector and/or Doppler domain bases indices indication may be provided herein.

The WTRU may include an indication for the NNZCs for W_2's (e.g., all W_2's) or a group of W_2's in part 1 of a CSI report (e.g., which may carry the legacy PMI or PMI_1/4/5), for example, when the NNZCs are equal in all W_2's for fixed W_1 and W_f or a group of W_2's for fixed W_1 and W_f. The remaining CSI reports which carry one or more component precoders (e.g., CSI reports carrying PMI_2/3/6) may not have part 1 associated with the CSI reports.

A WTRU may report indication of the NNZCs for each W_2 and/or a group of W_2s in part 1 of a CSI report, (e.g., when the NNZCs are different in each or a group of W_2 matrices).

A WTRU may indicate the number of W_2 matrices with the same NNZC. In examples, a WTRU may use log₂ NZT number of bits in part 1 of a CSI report to indicate the NNZCs. The NNZCs may be bounded as NNZCs≤NZT. A WTRU may indicate the number of W_2 matrices and/or the indices of W_2 matrices having equal NNZCs.

In examples, a WTRU may include ┌log_2 {N}┐ bits in part 1 of a CSI report to indicate the number of W_2 matrices with equal NNZCs. In examples, a WTRU may include

$$⌈ log\_ 2 ( \begin{matrix}N \\ {N}^{′}\end{matrix} ) ⌉ bits$$

to indicate indices of N′ number of W_2 matrices out of N number of W_2 matrices with an equal NNZCs.

Based on a Doppler-related measurement, a WTRU may select a single figure as the NNZC for all W_2s (e.g., even if the actual NNZCs are not equal). The WTRU may include the indication for the NNZCs for W_2's (e.g., all W_2's) or a group of W_2's in part 1 of a CSI report.

The NNZCs per layer may be upper bounded across all Doppler domain bases vectors D. A WTRU may be configured with a different number of Doppler domain compression parameters and/or frequency domain compression parameters for upper bounding the NNZCs across all Doppler domain bases D. For example, for D number of Doppler domain bases, the NNZCs on layer 1 may be upper bounded as K_0=┌2LM_lαβD┐, wherein K_0 represents an upper bound on the NNZCs. Therein, B is a frequency domain compression parameter, where 0<β≤1 and α is a Doppler domain compression parameter, where 0<α≤1. In examples, the WTRU may be configured with different values of a based on a different number of beams, layers, and/or Doppler domain bases vectors D and/or the observed Doppler. The value of a may be radio resource control (RRC) configured. The WTRU may also report a in a TDCP and/or CSI report. The WTRU may be configured with different values of α and β based on different settings of the number of beams and/or layers.

The NNZCs across all layers and/or Doppler domain bases D may be upper bounded as a function of K_0. The NNZCs across all layers and DD bases D may be upper bounded as NNZCs=┌q, K_0┐, where q>0. In some examples, a WTRU may be configured with different values of q based on Doppler. Additionally or alternatively, a fixed value of q may also be defined. A smaller value of q may be defined for a smaller Doppler and/or a larger value of q may be defined for higher Doppler, or vice versa.

In examples, the NNZCs may be upper bounded across each Doppler domain bases vector. The WTRU may be configured with different Doppler domain compression parameters and/or different frequency domain compression parameters for upper bounding the NNZCs across each Doppler domain bases. For example, for each Doppler domain base, the NNZCs on layer 1 may be upper bounded as K_0=┌2LM_lαβ┐. Therein, β is a frequency domain compression parameter, where 0<β≤1 and α is a Doppler domain compression parameter, where 0<α≤1. In examples, a WTRU may be configured with different values of a based on different number of beams, layers and/or Doppler domain bases vectors D and/or the observed Doppler. The value of a may be RRC configured. The WTRU may also report a in a TDCP and/or CSI report. The WTRU may be configured with different values of α and/or β based on different settings of the number of beams and/or layers.

A WTRU may be configured (e.g., only be configured) with frequency domain compression parameters for upper bounding the NNZCs across each Doppler domain base. A WTRU may be configured with smaller values of β for higher Doppler; higher values of β for smaller Doppler; smaller values of β when the number of Doppler domain bases D is larger; and/or higher values of β when the number of Doppler domain bases D is smaller. The WTRU may be configured with different value of α and/or β for different settings of the number of beams and/or layers.

The NNZCs across all layers and/or Doppler domain bases D may be upper bounded as a function of K_0. The NNZCs across all layers and/or DD bases D may be upper bounded as NNZCs=┌q, K_0┐, where q>0. In examples, a WTRU may be configured with different values of q based on Doppler. Additionally or alternatively, a fixed value of q may also be defined. A smaller value of q may be defined for a smaller Doppler and/or a larger value of q may be defined for higher Doppler, or vice versa.

A WTRU may report one strongest coefficient per layer for each W_2 matrix. In a low Doppler scenario, beam/polarization and/or DFT vector index of the strongest coefficient may remain constant over longer periods. However, in a high Doppler scenario, beam/polarization, DFT vector and/or Doppler domain bases index of the strongest coefficient may change at a faster rate.

A WTRU may report one (e.g., only one) strongest coefficient for all W_2's and/or for multiple component precoders (e.g., PMI_2/4/6). A WTRU may report one common wideband coefficient for all W_2's or multiple component precoders (e.g., PMI_2/4/6). A WTRU may determine the number of W_2 matrices or component precoders with one strongest coefficient and a common wideband coefficient based on the observed Doppler.

A WTRU may report beam/polarization index of the strongest coefficient; the index of the W_2 matrix with the strongest coefficient; and/or the index of the DD bases with the strongest coefficient.

In examples, when the observed Doppler is less than a threshold, the strongest coefficient may remain the same over multiple W_2's and/or multiple component precoders. A WTRU may report the beam index of the strongest coefficient for multiple W_2's and/or multiple component precoders as a high priority element in a CSI report.

A WTRU may use ┌log_2 2L┐ bits to indicate the beam/polarization of the strongest coefficient and/or the index of the W_2 matrix with the strongest coefficient. Therein, N may be the total number of W_2 matrices with fixed W_1 and/or W_f. The WTRU may also use ┌log_2 D┐ bits to indicate the index of the Doppler domain bases with the strongest coefficient, where D may be the total number of Doppler domain bases.

A WTRU may only report one strongest coefficient for all N W_2 matrices or all D Doppler domain bases. The WTRU may remap the indices of the N W_2's such that a W_2 matrix with the strongest coefficient may be indexed at zero. Then, a WTRU may report index of the strongest coefficient by only reporting the beam/polarization index of the strongest coefficient. In an example, let n*∈{0, 1, . . . , N} be the index of the W_2 matrix with the strongest coefficient. Further assume that n′=k, where 0<k<N and n′={0, 1, 2, . . . , k−1, k, k+1, . . . , N}. The W_2 indices may therefore be remapped as {k, k+1, . . . , N, 0, 1, 2, . . . , k−1}.

In examples, d*∈{0, 1, . . . , D} may be the index of the Doppler domain bases with the strongest coefficient. Further, in some examples, d′=k, where 0<k<D and d*={0, 1, 2, . . . , k−1, k, k+1, . . . , N}. The Doppler domain bases indices may be remapped as {k, k+1, . . . , N, 0, 1, 2, . . . , k−1}.

A WTRU may report one strongest coefficient for each legacy PMI and/or each component precoder (e.g., PMI_2/4/6; the beam index of the strongest coefficient for each legacy PMI and/or each component precoder; and/or one wideband coefficient for each legacy PMI and/or each component precoder (e.g., PMI_2/4/6).

In examples, a WTRU may report a strongest coefficient (e.g., one strongest coefficient) and/or a wideband coefficient (e.g., one wideband coefficient) per legacy PMI and/or per component precoders. The WTRU may report based on the observed Doppler (e.g., when the observed Doppler is greater than some threshold).

A WTRU may report a beam index of a coefficient (e.g., one strongest coefficient) and/or a wideband coefficient (e.g., one wideband coefficient) for a group of component precoders. The WTRU may determine a group of component precoders with a common strongest coefficient and/or wideband coefficient based on the observed Doppler.

In examples, a WTRU may determine a group of component precoders with the common strongest beam such as when the observed Doppler is between two thresholds. The WTRU may use an indication to report the beam index of the strongest coefficient. Ther WTRU may use a second indication to indicate the indices of the W_2 matrices with a common strongest coefficient. In examples, the WTRU may include

$$⌈ log\_ 2 ( \begin{matrix}N \\ {N}^{′}\end{matrix} ) ⌉ bits$$

in a CSI report to indicate indices of N′ number of W_2 matrices out of N number of W_2 matrices with the same strongest coefficient.

Regarding non-zero coefficient (NZC) indices, a WTRU may report beam/polarization and DFT vector indices of NZCs per layer using a bitmap of length 2LM_v bits, where L is the number of beams and M_v is the number of DFT vectors (e.g., in Rel. 16/17). In high Doppler scenarios, when reporting multiple W_2's and/or multiple component precoders for fixed W_1 and W_f, the overhead of reporting indices of the NZCs may increase (e.g., significantly). A plurality of methods are provided herein for reporting beam/polarization, and/or DFT vector indices of NZCs for multiple W_2's and/or multiple component precoders. In some examples, N may refer to the number of Doppler domain DFT bases vectors.

A WTRU may use an indicator to report the NNZC's for N W_2's and/or N component precoders. In examples, the WTRU may use a bitmap of length 2LM_vN, where bit “1” of the bitmap may indicate beam/polarization and DFT vector index of a NZC and bit “0” of the bitmap may indicate a beam/polarization and DFT vector index of a zero-coefficient. Additionally or alternatively, the WTRU may use a bitmap of length 2LM_vN, where bit “0” of the bitmap may indicate beam/polarization and DFT vector index of a NZC and bit “1” may indicate beam/polarization and DFT vector index of a zero-coefficient.

A WTRU may report beam/polarization and DFT vector indices of the NZCs using

$$⌈ {log}_{2} ( \begin{matrix}2 {LM}_{v} N \\ {K}_{NZ}\end{matrix} ) ⌉ bits ,$$

where K_NZ is the NNZC in N W_2 matrices and/or N component precoders or N number of Doppler domain DFT bases vectors. Additionally or alternatively, the WTRU may report beam/polarization and DFT vector indices of zero-coefficients using

$$⌈ {log}_{2} ( \begin{matrix}2 {LM}_{v} N \\ 2 {LM}_{v} N - {K}_{NZ}\end{matrix} ) ⌉ bits .$$

Therein, K_NZ is the NNZC in N W_2 matrices, N component precoders, and/or N number of Doppler domain DFT bases vectors.

A WTRU may use an indicator to report the beam/polarization, and DFT vector indices of the NZCs, where the indicator may have two sub-indicators. The first sub-indicator may report indices of W_2 matrices and/or component precoders with NZCs. The second sub-indicator may report beam/polarization, and DFT vector indices of NZCs in each W_2 matrix or each component precoder.

If all W_2 matrices and/or component precoders have NZCs, then a WTRU may report a 1 bit indication in the uplink control information (UCI) to indicate whether all N W_2 matrices of component precoders have NZCs or not. If the 1 bit indication indicates that all W_2 matrices of component precoders have NZCs, then a WTRU may choose to exclude the first sub-indicator of length N used for indices indication of component precoders with NZCs. Additionally or alternatively, if the 1 bit indication indicates that not all W_2 matrices have NZCs, then the WTRU may choose to include the first sub-indicator of length N used for indices indication of the component precoders with NZCs.

In examples, a WTRU may use a first bitmap of length N, where bit “1” of the bitmap may indicate the index of the W_2 or component precoder with NZCs and/or bit “0” of the bitmap may indicate index of the W_2 matrix or index of a component precoder with all zero-coefficients. In examples where the first bitmap includes R ones and N-R zeros, the WTRU may use a bitmap of length 2LM_vR to indicate the beam/polarization and DFT vector indices of the NZCs.

In examples, a WTRU may use a first sub-bitmap of length

$$⌈ {log}_{2} ( \begin{matrix}N \\ R\end{matrix} ) ⌉ bits$$

to report indices or W_2 matrices with NZCs and/or a second sub-bitmap of length

$$⌈ {log}_{2} ( \begin{matrix}2 {LM}_{v} R \\ {K}_{NZ}\end{matrix} ) ⌉ bits ,$$

where K_NZ Is the NNZC in all W_2 matrices and/or in all component precoders, for reporting beam/polarization and DFT vector indices of the NZCs. Moreover, a WTRU may use an indicator with three sub-indicators to report the beam/polarization and DFT vector indices of the coefficients of n_th W_2 matrix whose zero or non-zero states has changed or remained unchanged as compared to the last (e.g., n_th−1 W_2 matrix).

A first sub-indicator may be used to indicate that the next two sub-indicators will report coefficients of the n_th W_2 matrix whose zero or non-zero state has changed or remained unchanged as compared to the n_th−1 W_2 matrix. The second sub-indicator may be used to indicate the number of coefficients of n_th W_2 matrix whose zero or non-zero state has changed or has remained unchanged as compared to the n_th−1 W_2 matrix. The third sub-indicator may be used to indicate the beam/polarization and DFT vector indices of the coefficients whose zero or non-zero state has changed or unchanged.

In examples, a WTRU may use 1 bit indication to report to the gNB that the next two sub-indicators will report beam/polarization and DFT vector indices of NZCs of n_th W_2 matrix n whose location has changed as compared to the n_th−1 W_2 matrix. Bit 1 may indicate changed and bit 0 may indicate unchanged coefficients. A second bitmap of length ┌log₂ K_CL┐ may be used to indicate the number of coefficients whose beam/polarization and DFT vectors state has changed. Therein, K_CL is the number of zero or non-zero coefficients whose state in n_th W_2 has changed as compared to n_th−1 W_2.

A third bitmap of length

$$⌈ log\_ 2 ( \begin{matrix}2 {LM}_{v} \\ {K}_{CL}\end{matrix} ) ⌉ bits$$

may be used to indicate the beam/polarization and DFT vector indices of the coefficients whose state has changed or remained unchanged.

A WTRU may use an indicator with two sub-indicators to report the beam/polarization and DFT vector indices of NZCs. The first indicator may be used to indicate that the second indicator will report coefficients of n_th W_2 matrix whose coefficient state has changed or has remained unchanged as compared to the n_th−1 W_2 matrix. The second indicator may be used to report the beam/polarization and DFT vector indices of the coefficients in n_th W_2 matrix whose zero/non-zero state has changed as compared to the n_th−1 W_2 matrix.

A WTRU may determine the NNZCs K_ch in the n_th W_2 matrix whose non-zero state has changed as compared to the n_th−1 W_2 matrix. The WTRU may use a bitmap of length ┌log_2 K_ch┐ to indicate the NNZCs whose non-zero state has changed. The WTRU may use a second bitmap of length

$$⌈ log\_ 2 ( \begin{matrix}2 {LM}_{v} \\ {K}_{c} h\end{matrix} ) ⌉ bits$$

to indicate the beam/polarization and DFT vector indices whose non-zero state has changed.

A WTRU may consider (e.g., only consider) a partial set of beams and/or DFT vectors for reporting their zero and/or NZC state. The WTRU may prioritize reporting the zero/NZC state of beam and/or DFT vectors which are closer to the beam and DFT vector having the strongest coefficient. The WTRU may deprioritize and/or exclude reporting the zero/NZC state of beam and/or DFT vector with the weakest coefficient. The WTRU may deprioritize and/or exclude reporting the zero/NZC state of beam and/or DFT vectors closer to the beam and/or DFT vector with the weakest coefficient. The WTRU may choose 0≤L₁<L beams and/or 0≤L₂≤L beams, where L₁+L₂≤L−1 starting from the beam with the strongest coefficient before remapping the DFT codebook indices. The WTRU may not report the zero/non-zero coefficient state on the corresponding 0≤Mᵥ₁≤Mᵥ and/or 0≤Mᵥ₂≤Mᵥ DFT vectors of the chosen L_1 and L_2 beams, where Mᵥ₁+Mᵥ₂≤Mᵥ−1. Additionally or alternatively, a WTRU may only report zero/non-zero state of coefficients pertaining to DFT vectors of a beam other than Mᵥ₁ and Mᵥ₂.

In examples, a WTRU may report average beam/polarization and DFT vector indices of NZCs for multiple W_2 matrices. The WTRU may report average beam/polarization and DFT vector indices of NZCs for all N Doppler domain bases vectors.

NZCs are the non-zero amplitude coefficients and phase coefficients in W_2. In Rel. 16/17, each NZC requires 7 bits for reporting. Each amplitude coefficient requires 3 bits and each phase coefficient requires 4 bits for reporting. Most of the feedback overhead in a Type-II CSI report is generated by NZCs.

A WTRU may perform a plurality of different functions, for example, to reduce feedback overhead when reporting NZCs. In examples, a WTRU may quantize different amplitude coefficients and/or different phase coefficients with different resolutions.

A WTRU may determine one or more amplitude thresholds. A WTRU may quantize a higher amplitude coefficient with a higher resolution and/or a smaller amplitude coefficient with a smaller resolution.

A WTRU may quantize amplitude/phase coefficients (e.g., all amplitude/phase coefficients) of one or more beams, and/or amplitude/phase coefficients (e.g., all amplitude/phase coefficients) of one or more polarizations of one or more beams. The WTRU may quantize amplitude/phase coefficients (e.g., all amplitude/phase coefficients) of one or more layers with a higher quantization resolution as compared to the quantization resolution of amplitude/phase coefficients on other beams, polarizations, and/or layers.

A WTRU may use an indicator to report one or more beam indices, polarizations indices, and/or layer indices whose amplitude/phase coefficients are quantized with a higher and/or smaller resolution.

In examples, a WTRU may use

$$⌈ log\_ ( \begin{matrix}x \\ y\end{matrix} ) ⌉$$

number or bits to report beam/polarization, and/or layer indices whose amplitude/phase coefficients are quantized with a higher resolution as compared to the quantization resolution of non-zero amplitude/phase coefficients on other beams, polarizations and/or layers. Therein, x may denote the total number of beams, polarizations, and/or layers. Therein, y may denote the number of beams, polarizations, and/or layers whose amplitude/phase coefficients uses a higher or lower quantization level as compared to amplitude/phase coefficients of other beams, polarizations, and/or layers.

In examples, a WTRU may use a bitmap of length x, where bit “1” of the bitmap indicate a beam/polarization or layer index whose non-zero amplitude/phase coefficients are quantized with a higher or smaller resolution as compared to NZCs on other beams, polarization, and/or layers.

A WTRU may quantize one or more amplitude/phase coefficients on one or more beams with a smaller or higher quantization resolution as compared to the quantization resolution of the remaining amplitude/phase coefficients on the same set of beams.

A WTRU may use an indicator to report one or more NZC indices using a higher or a smaller quantization resolution as compared to the quantization resolution of the remaining amplitude coefficients on the same set of beams.

In examples, a WTRU may use

$$⌈ log\_ ( \begin{matrix}x \\ y\end{matrix} ) ⌉$$

number of bits to report y number of DFT vector indices on which the NZCs are quantized with a higher or smaller resolution as compared to the quantization resolution of the remaining amplitude coefficients on the same set of beams.

In examples, a WTRU may use a bitmap of length x, where bit “1” of the bitmap may indicate DFT vector index whose non-zero amplitude coefficient is quantized with a higher resolution and bit ““0’ of the bitmap may indicate DFT vector index whose non-zero amplitude coefficient is quantized with a smaller resolution. Additionally or alternatively, a WTRU may use a bitmap of length x, where bit “1” of the bitmap may indicate DFT vector index whose non-zero amplitude coefficient is quantized with a smaller resolution and bit “0” of the bitmap may indicate DFT vector index whose non-zero amplitude coefficient is quantized with a higher resolution

For a given NZC, with one amplitude coefficient and/or one phase coefficient, a WTRU may use a higher quantization resolution for the amplitude coefficient and a lower quantization resolution for the phase coefficients. Additionally or alternatively, for a given NZC, with one amplitude coefficient and/or one phase coefficient, a WTRU may use a smaller quantization resolution for the amplitude coefficient and/or a higher quantization resolution for the phase coefficients. Additionally or alternatively, for a given NZC, with one amplitude coefficient and/or one phase coefficient, a WTRU may use the same quantization resolution for both coefficients.

A WTRU may quantize all or some amplitude/phase coefficients of a beam and/or layer with a higher or a smaller resolution based on the Doppler experienced by the beam and/or layer. In examples, the WTRU may quantize all or some amplitude/phase coefficients of a beam and/or layer experiencing higher Doppler with higher resolution. The WTRU may quantize all or some amplitude/phase coefficients of a beam and/or layer experiencing smaller Doppler with smaller quantization.

A WTRU may quantize y number of amplitude/phase coefficients of a layer as set forth herein.

Specifically, a WTRU may quantize the first 0≤y₁≤y number of amplitude/phase coefficient with resolution l_1 and the remaining y−y_1 number of amplitude/phase coefficients with resolution l_2, where l_1 may be greater than l_2, or vice versa. The WTRU may use an indicator to indicate the quantization level of the first y_1 amplitude/phase coefficients, quantization level of the remaining y−y_1 amplitude/phase coefficients, and the number of the first y_1 number of amplitude/phase coefficients with quantization level l_1.

A WTRU may use a bitmap of length ┌log₂ y┐+1 bits. Therein, 1 bit may be used to indicate that the first y_1 number of amplitude/phase coefficients are quantized with l_1 or l_2 resolution. The remaining bits may indicate the number of y_1 amplitude/phase coefficients using resolution l_1 and/or l_2 resolution.

In examples, a WTRU may quantize amplitude/phase coefficients of beams and/or DFT vectors which are closer to the beam and DFT vector having the strongest coefficient with a higher resolution and/or having the weakest coefficient with a smaller quantization resolution.

In examples, a WTRU may choose 0≤L₁<L beams and/or 0≤L₂<L beams, where L₁+L₂≤L−1 starting from the beam with the strongest coefficient before remapping the DFT codebook indices. The WTRU may also choose 0≤Mᵥ₁≤Mᵥ and/or 0≤Mᵥ₂≤Mᵥ DFT vectors starting from the DFT vector with the strongest coefficient before remapping the DFT codebook indices. On the chosen beams/polarization and DFT vectors grid, a WTRU may use a higher quantization level and/or may use a smaller quantization level of the remaining beam/DFT vector grid.

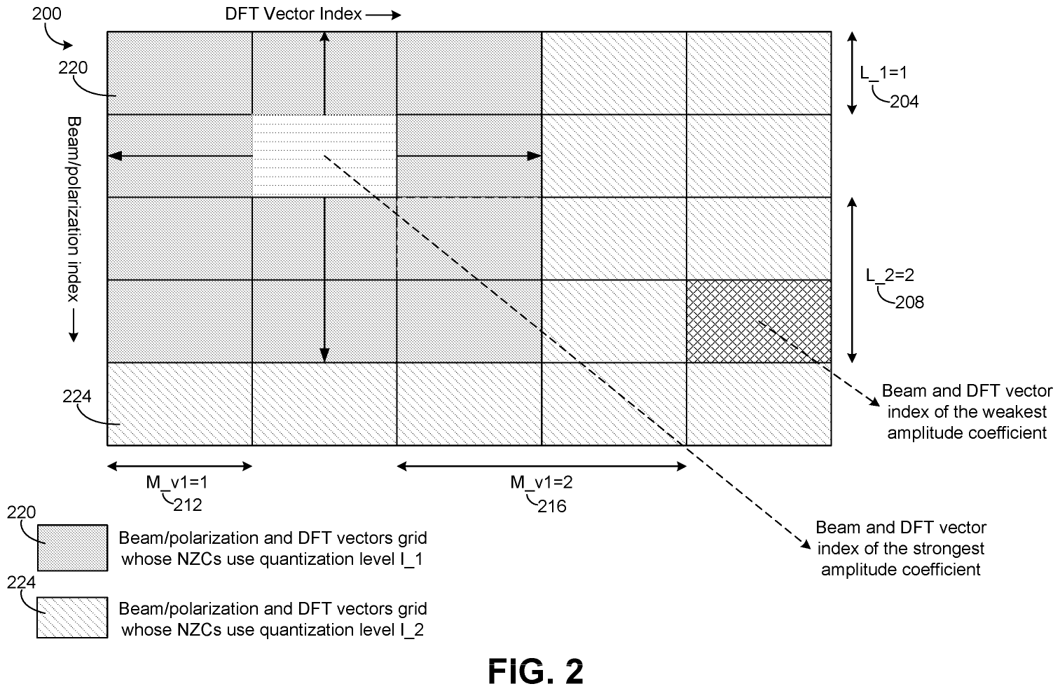

FIG. 2 illustrates an example grid 200 of different quantization resolutions for different beams/polarizations and DFT vector indexes. The WTRU may use an indicator to indicate the number of beams L_1 204 and/or L_2 208. For example, a WTRU may use ┌log_2L/2┐ number of bits to indicate L_1 204 and ┌log_2 L/2┐ number of bits to indicate L_2 208. The WTRU may use an indicator to indicate the number of M_v1 212 and M_v2 216. The WTRU may use ┌log₂Mᵥ┐ number of bits to indicate M_v1 212 and ┌log₂ Mᵥ┐ number of bits to indicate M_v2 216. The WTRU may receive L_1 204, L_2 208, M_v1 212, and/or M_v2 216 from the gNB.

A WTRU may use P different quantization levels for the same or different W_2 matrices based on the amplitude levels. For example, the WTRU may use quantization level l_1 220 and switch to quantization level l_2 224 when the amplitude level significantly changes. The WTRU may use an indication to inform gNB that the quantization resolution has changed (e.g., from l_1 220 to l_2 224). A WTRU may use ┌log_2 P┐ bits to indicate the use of l_1 220, l_2 224, . . . or l_P quantization resolution.

A time domain channel property (TDCP) report is a report that includes relevant information about the time variations of the channel (e.g., Doppler shift, Doppler spread, and/or time correlation, etc.). A WTRU may support measurement capability for one or more types of TDCP content. For example, a WTRU may measure only Doppler shift, while another WTRU may measure either Doppler shift and/or time correlation. A WTRU may indicate its supported type(s) of TDCP measurements. If a WTRU supports more than one type of TDCP measurement, the WTRU may receive an indication as what TDCP measurement to report. If a WTRU indicates support of only one type of TDCP measurement, the WTRU may report the supported TDCP content. The WTRU may determine the Doppler characteristics and report a standalone-report for the one or more TDCPs of the channel. Since the change in Doppler may be less frequent, the periodicity of the TDCP report may be higher. In smaller Doppler scenarios, the periodicity of the TDCP report may be much higher as compared to higher Doppler scenarios.

A WTRU may configure a standalone report to report the TDCP of the channel. The TDCP may or may not depend on other parameters of a CSI report. The TDCP report may include parameter p_s, which may be used for the determination of the number of Doppler domain bases. The TDCP report may be triggered, dropped, and/or prioritized based on the Doppler. The WTRU may drop a TDCP report based on the observed Doppler and/or if the WTRU observes that the Doppler is less than a threshold. The WTRU may prioritize or deprioritize one TDCP report over another TDCP report based on change in the Doppler. If the WTRU observes that the Doppler is less than a threshold, the WTRU may report Doppler shift and/or Doppler spread as TDCP information in a CSI report as a high priority element. The WTRU may report the TDCP information in a CSI report when the N is less than a threshold, D is less than a threshold, and/or the difference N-D is less than a threshold.

A WTRU may drop a TDCP report and/or transmit a null information if the WTRU determines that the CL or accuracy of the estimated TDCP content is below a threshold. The report may indicate a null value for the estimated TDCP content when the CL is determined to be below the threshold. The threshold may be fixed and/or configured by the gNB. A gNB-based configuration may be based on a reported WTRU capability. In examples, if a WTRU does not drop a TDCP report, the WTRU may implicitly and/or explicitly indicate a request for an increase in TRS transmission. The request may be an aperiodic TRS transmission, a semi-persistent TRS transmission, and/or a periodic TRS transmission (e.g., with a higher TRS density, etc.). In examples, each mode may be RRC and/or MAC configured and/or identified by an index indicated by a WTRU.

To support the TDCP report, a WTRU may perform measurement on a downlink signal or channel. For example, the WTRU may receive a downlink reference signal on a downlink channel. Once a WTRU is configured to report the TDCP, the WTRU may perform measurement on the downlink reference signal (e.g., TRS). For example, the WTRU may measure a Doppler related parameter value based on the downlink reference signal.

A WTRU may be configured to report TDCP on a periodic basis (e.g., T_tdcp). The WTRU may have an independent configuration for the periodicity of the TDCP report. Additionally or alternatively, a WTRU may determine the periodicity of the report as T_tdcp=LxT_ref, where L is a scaling factor, and T_ref is the periodicity of the transmission of the reference signal. For example, when a WTRU is configured with a TRS burst periodicity transmission of T_trs=10 ms, and a scaling factor of L=4, then the WTRU may report every 40 ms.

The scaling factor L may be fixed or configurable indicated by an implicit and/or explicit indication through a semi-static configuration. The RRC may initially configure the scaling factor L to control the overhead and reliability of the system. A medium access control control element (MAC-CE) and/or a downlink control information (DCI) may dynamically update the periodicity of the TDCP.

The time/frequency resource for the TDCP report may be determined in a semi-static or dynamic manner. In examples, a dedicated time/frequency resource (e.g., a configured grant) may be defined as part of the TDCP configuration. In this configuration, a specific preconfigured resource may be used. For example, a WTRU may report the TDCP in a designated frequency resource location by PUSCH and/or PUCCH in slot i+n, where l is a reference slot related to the TRS burst (e.g., first or last, and n is the slot offset containing the frequency resource). The slot offset n may be fixed and/or indicated with the PUSCH grant. The TDCP configuration may include at least one PRI as an indication of the PUCCH resources used for the TDCP report.

A WTRU may receive a trigger (e.g., by a DCI) to report an aperiodic TDCP report. The time/resource configuration for a WTRU may have an independent configuration for the aperiodic TDCP report and/or a common configuration may be used for both periodic and/or aperiodic TDCP report. Additionally or alternatively, the triggering DCI may indicate at least one of time and/or frequency resources for transmission of the TDCP report. The indication in the triggering DCI may be simply an index to select one of the preconfigured resources for transmission of the TDCP report.

In examples, a CSI request field (e.g., or a new and/or other field) in a DCI (e.g., a UL-related DCI, such as DCI format 0_1, 0_2) may be used for the indication triggering an aperiodic TDCP report. The CSI request field (e.g., or a new/other field) may comprise one or more codepoints where a codepoint of the one or more codepoints may be associated. For example, a codepoint may be associated via a higher-layer signaling (e.g., RRC and/or MAC-CE) with an aperiodic TDCP report. The WTRU may receive an indication/configuration that the aperiodic TDCP report is associated with a first TRS (e.g., a first channel state information reference signal (CSI-RS) resource set comprising a TRS-enabling parameter (e.g., TRS-info) set to ‘ON’), where the first TRS may be a periodic TRS or an aperiodic TRS. The WTRU may determine the aperiodic TRS is associated with a periodic TRS, based on an explicit and/or implicit indication/association, for example, when (e.g., on a condition that) the first TRS is the aperiodic TRS.

In examples, a second codepoint of the one or more codepoints may be associated via a higher-layer signaling (e.g., RRC and/or MAC-CE), with a second aperiodic TDCP report. The WTRU may receive an indication/configuration that the second aperiodic TDCP report may be associated with a second TRS (e.g., a second CSI-RS resource set comprising a TRS-enabling parameter, such as TRS-info, may be set to ‘ON’). Therein, the second TRS may be a periodic TRS or an aperiodic TRS.

When the second TRS is the aperiodic TRS, the WTRU may associate the aperiodic TRS with a periodic TRS, based on an explicit and/or implicit indication and/or association. This association may provide benefits in terms of efficiency and flexibility on estimating and/or measuring TDCP, e.g. that a gNB may configure more than one TRS (e.g. each associated with a separated TDCP reporting which may be triggered selectively by the DCI). Therein, each TRS may have a different reference signal (RS) density so that a preferred TDCP reporting may be selectively triggered for the WTRU.

In examples, the first TRS may have higher RS density in time-domain, and the second TRS may have lower RS density in time-domain. The gNB may trigger the first aperiodic TDCP report when higher Doppler effects are observed/estimated. Additionally or alternatively, the gNB may trigger the second aperiodic TDCP report when lower Doppler effects are observed/estimated.

Triggering of the first aperiodic TDCP report and/or triggering of the second aperiodic TDCP report may be associated with a (e.g., same) codepoint of the one or more codepoints. The WTRU may receive a DCI comprising a TDCP-triggering field (e.g., the CSI request field or a new/other field) indicating the (e.g., same) codepoint, the WTRU may determine to transmit both the first aperiodic TDCP report and/or the second aperiodic TDCP report, based on one or more parameters associated with the transmission. This determination may provide benefits in terms of latency reduction on adjustments for subsequent CSI reporting and associated WTRU behaviors. Benefits may include, but are not limited to: that the gNB may receive both TDCP reports, each associated with a different TRS (e.g., with different RS-related parameter(s) including RS density, beam-direction, and/or QCL information, etc.). Making a determination after receiving both TDCP reports may allow the gNB to decide necessary adjustments based on receiving both TDCP reports with one TDCP-triggering DCI.

TDCP report may be configured as a semi-persistent process. A WTRU may receive a DCI to activate a TDCP report. The configuration may include the period of time T for which the TDCP may be active. For example, a WTRU may receive a DCI in slot n to activate a TDCP report. The WTRU may generate TDCP reports between n and n+T. The periodicity, contents, and/or other parameters of the TDCP report may be preconfigured.

Since the TDCP may be a standalone report, some acknowledgment mechanism may be required if the TDCP is transmitted over PUCCH. A CSI report may be linked to a TDCP report. For example, when a WTRU reports its CSI, the WTRU may indicate whether the Doppler has changed significantly since the last TDCP report or not. The indication may be implicit and/or explicit using a single bit. By receiving such an indication, a gNB may decide for the timing of the next TDCP report (e.g., whether to trigger an aperiodic TDCP report and/or whether to change the periodicity of the TDCP report). For example, no immediate TDCP report may be needed when the ongoing Doppler remains in the range of the last TDCP report. However, if the ongoing Doppler exists out of the range of the last TDCP report, gNB may trigger WTRU for an imminent TDCP report.

Whether the WTRU may indicate that the TDCP report is out of range may depend on configuration. For example, the WTRU may receive, via configuration, an offset value. If the difference between the Doppler value reported in the last TDCP at time t1, and the Doppler value measured at a time t2>t1 is greater than an offset, the WTRU may send an indication.

The WTRU may further validate the last TDCP report. Additionally or alternatively, each TDCP report may have an index. The index may be related to the slot number (e.g., mod (slot_number, 10). Then, when a WTRU receives a PDSCH grant, the WTRU may receive the index associated to the last TDCP report to determine whether the last TDCP report has been received successfully.

The WTRU may validate the TDCP report by using timing restriction on the PDSCH grant. For example, the WTRU may introduce a fixed or preconfigured timing for receiving a PDSCH grant (e.g., for data or CSI) as an acknowledgment for the reception of the TDCP report. For example, if a WTRU receives a PDSCH grant n slot after the slot reporting the TDCP, the WTRU may interpret the grant as an acknowledgement of the last TDCP report.

The WTRU may act based receiving on a subsequent TDCP request within a time period. For example, if the WTRU receives a subsequent TDCP report from the network within a given duration provided by the previous WTRU report, then the WTRU may assume that the previously reported TDCP report was unsuccessful.

The WTRU may act upon reception of a configuration. For example, if the WTRU receives a subsequent configuration in response to a previous TDCP report, the WTRU may assume that the TDCP report has been successfully received.

If the WTRU determines and/or suspects that a previously reported TDCP was not successfully received, the WTRU may take proactive action to transmit the TDCP report. Whether the WTRU may take proactive action may be based on configuration, and/or subject to conditions (e.g., the values within the TDCP report have exceeded a threshold). Examples of proactive actions the WTRU may take include, but are not limited to: sending the current TDCP report; sending the previous TDCP report; indicating when the previously reported TDCP report occurred (e.g., via timestamp), and/or providing an indication the WTRU suspects the report may have been unsuccessful. The WTRU may send an indication the TDCP report was unsuccessfully sent, for example, within the TDCP report, and/or via an additional indication (e.g., via MAC CE, RRC signaling, and/or UCI).

The WTRU may employ a timing restriction on TDCP reporting. For example, a WTRU may send TDCP reports partially and/or entirely as a function of a WTRU determined trigger such as event-based and/or measurement-based triggering. For example, if a threshold (e.g., Doppler) is configured, the WTRU may send a TDCP report whenever the WTRU determines that the Doppler exceeds the threshold. However, this may cause the WTRU to generate several TDCP reports which can generate a large amount of uplink (UL) traffic.

A WTRU may be configured with a restricted number of TDCP reports to transmit over a time period. For example, a WTRU may receive a CSI reporting configuration or TDCP configuration with a configured integer N number of TDCP reports, and/or a time period T (e.g. in slots and/or seconds). The WTRU may determine to send N TDCP reports within the time period T. T may be defined relative to a triggering event (e.g., within a period T after a WTRU triggers a TDCP, and/or receives a TDCP triggering command). Additionally or alternatively, T may be defined starting after a WTRU sends a first TDCP report. The WTRU may determine to send the TDCP reports in equally divided time instances (e.g., every T/N), and/or explicitly indicated time instances within the time period T (e.g., at times t1, t2, t3, . . . , tN).

A WTRU may transmit only one TDCP report within a time period T. For example, the WTRU may receive a TDCP reporting configuration which indicates to transmit a TDCP whenever a measurement (e.g. Doppler spread and/or Doppler shift, etc.) rises above a configured threshold. The WTRU may measure a Doppler spread above a threshold and be triggered to report a TDCP. After generating and/or transmitting the TDCP report, the WTRU may be configured to transmit the next TDCP report at a time instance T or greater than the previous TDCP reporting time instance. This configuration avoids transmitting multiple TDCP reports within the T period where the measurement may cross the threshold more than one time.

A secondary threshold may be defined such that a WTRU may generate a new TDCP report only if the measurement varies by a value greater than the secondary threshold. For example, a WTRU may receive a first threshold on the WTRU velocity, wherein a WTRU triggers a TDCP report if the WTRU velocity, v, exceeds v_threshold (e.g., in kilometers per hour). If the WTRU crosses this first threshold, the WTRU may use a secondary threshold to determine if further TDCP reports are sent. For example, the secondary threshold may be defined as v_threshold_variance, and a WTRU may generate a new TDCP report if the instantaneous measurement (e.g., v_inst) exceeds than v_threshold by a quantity greater than v_threshold_variance (e.g., [v_inst−v_threshold]>v_threshold_variance).

A WTRU may use one or more thresholds to determine the contents of a TDCP report and/or when to send a TDCP report. For example, a WTRU may trigger the TDCP report only when v_threshold is crossed and/or when the velocity, v, remains within v_threshold_variance of the v_threshold. If only the v_threshold is crossed, a WTRU may include in its TDCP report an indication that the WTRU measurement (e.g., velocity) has not stabilized yet.

The WTRU may transmit only one indication (e.g. that the WTRU crossed only one threshold), and not transmit other parameters. The WTRU may transmit a follow-up TDCP report when the measurement has stabilized. The contents of the TDCP follow-up report may include additional parameters. The WTRU may determine when the measurement converges, and the WTRU may use an explicit bit (e.g., stabilization bit=1) in the TDCP report to indicate that the reported measurement stabilized. The gNB may refrain from requesting a new TDCP report. The WTRU may use the explicit stabilization bit setting of 0 to request additional TDCP triggers, and/or additional UL resources for additional TDCP reports.

The WTRU may be configured with a number of delay(s), (e.g., Y≥1) for determination of the TDCP. The WTRU may be configured with a threshold (D_basis), defined in terms of time-units. The parameters Y and D_basis may be fixed and/or configurable, indicated by an implicit and/or explicit indication through a semi-static configuration. The parameters may be jointly and/or separately configured. The parameters Y and/or D_basis may initially be configured by RRC. To handle channel variations and/or fulfill reliability requirements of the system, the paramers Y and D_basis may be dynamically updated by a MAC-CE and/or a DCI. The WTRU may receive an RRC configuration of the parameters Y and D_basis as part of an existing RRC configuration. In an example, the WTRU may receive the parameter values Y and D_basis as part of the ParamCombination. Additionally or alternatively, the WTRU may determine and report a value of the parameters Y and D_basis based on the use-case scenario and/or WTRU capability and/or channel conditions (e.g., delay spread and/or Doppler, etc.). The WTRU may report a separate indication for each parameter and/or the WTRU may report a single value to report a combination of the parameter values Y and D_basis.

The WTRU may determine TDCP (e.g., Doppler spread, Doppler shift, and/or time-domain correlation, etc.) of a downlink channel associated with (e.g., based on) a certain number of delays Y and/or a threshold D_basis. For example, the WTRU may estimate one or more TDCPs of the downlink channel based on the measured doppler related parameter value. The WTRU may determine TDCP based on delay(s) which is/are smaller than the threshold D_basis. When the WTRU is configured with Y=1 and/or the WTRU reports Y=1 and/or when the WTRU experiences several delays, the WTRU may choose a maximum delay that satisfies the threshold D_basis for determination of the TDCP. When the WTRU is configured with a value of Y that is greater than 1, and/or when the WTRU reports a value of Y greater than 1, the WTRU may choose delay(s) for the determination of TDCP, which are smaller than the threshold D_basis. When more than one delays are smaller than the threshold D_basis, the WTRU may choose the first Y_max number of maximum delays for estimation of the TDCP.

The WTRU may estimate a non-quantized TDCP denoted as A(t, τ). To report the estimated TDCP to the gNB, the WTRU may quantize the non-quantized estimated TDCP A(t, τ). The WTRU may be configured to quantize the non-quantized TDCP. The WTRU may quantize the amplitude and phase of A(t, τ) using the same or different number of bits. The WTRU may quantize the amplitude of A(t, τ) using higher number of bits as compared to the phase of A(t, τ). The WTRU may determine TDCP A_y(t, τ_y) based on more than one delays, e.g., y=1, . . . , Y.

The estimated TDCP may be denoted as ┌A_1(t, τ_1), A_2(t, τ_2), . . . , A_Y (t, τ_Y)┐. In some examples, the WTRU may classify the amplitude of TDCP estimated with the maximum delay as a reference for the amplitudes of the remaining TDCPs. The WTRU may report the TDCP estimated with the maximum delay with the highest resolution. In examples, let A_Y (t, τ_Y) be a measure of the TDCP calculated as a function of the maximum delay, (e.g., the maximum delay is the Y_th delay). The WTRU may report a value of A_Y (t, τ_Y)=1. The WTRU may determine the index y of a delay which results in a maximum value of TDCP. The WTRU may use the amplitude and/or phase of max (A_y(t, τ_y)) for y=1, . . . . Y as a reference for amplitude and/or phase reporting of the remaining TDCP estimates. Therefore, the WTRU may assign one or more of an amplitude value or a phase value to one or more TDCP estimates. In examples, the WTRU may assign an amplitude value of 1 and a phase value of 0 to the TDCP estimate max (A_y(t, τ_y)). The WTRU may quantize the amplitude and/or phase of the remaining TDCP estimates relative to the amplitude and phase of value of the max (A_y(t, τ_y)). The WTRU may report the index y of the delay which results in max (A_y(t, τ_y)) to the gNB as part of the TDCP report.

In a high Doppler scenario, the co-phasing coefficients W_2's changes at a faster rate, generating large feedback overhead. Doppler-domain compression with D number of bases having length N can compress W_2 matrices when D<N. Using specific Doppler domain bases for each beam may achieve superior compression performance as compared to using common Doppler domain bases for all beams at the expense of complexity.

A WTRU may use common Doppler domain bases for all beams and/or all layers whose associated Doppler is less than a threshold and/or whose amplitude coefficient is less than a threshold. A WTRU may use common Doppler domain bases for a beam, a group of beams, a layer and/or a group of layers, for example, if their associated Doppler is less than a threshold and/or their associated amplitude coefficients is less than a threshold. The amplitude may be determined based on Doppler.

A WTRU may add rotations to the Doppler domain bases for a beam, a group of beams, a layer and/or a group of layers based on the observed Doppler on the associated beam, group of beams, layer, and/or a group of layers. In examples, if the Doppler and/or amplitude of a certain beam, group of beams, layer, and/or a group of layers is higher than a threshold, a WTRU may add rotational value (e.g., exp(j(aₙ+a_{b})) where aₙ may be the phase of the bases and ap may be the added phase). The WTRU may determine the number of phase rotations and the value of each phase rotation based on the observed Doppler, the number of bases D, and/or the length of bases N.

In examples, a WTRU may use specific Doppler domain for each beam, group of beams, layer, and/or a group of layers whose corresponding Doppler is greater than a threshold and/or whose amplitude coefficient is greater than a threshold. The WTRU may apply additional rotation to the Doppler domain bases used for beam, group of beams, layer, and/or a group of layers. The WTRU may determine the number of rotations and/or the value of each rotation based on the Doppler observed on each beam, group of beams, layer, and/or a group of layers.

A WTRU may not use Doppler domain compression over a certain beam, group of beams, layer, and/or a group of layers. In examples, the WTRU may use identity bases on a certain beam, group of beams, layer, and/or a group of layers if their observed Doppler is less than some threshold. The WTRU may use identity bases if the difference between the length of the Doppler domain bases N and/or the number of Doppler domain bases D is less than a threshold (e.g., N−D<Doppler_threshold).

A WTRU may use identity bases as an indication of its Doppler domain compression capability. In examples, a WTRU may use identity bases to indicate that it is not fit to perform Doppler domain compression. In examples, a WTRU may use identity bases for beam, group of beams, layer, and/or a group of layers by setting the corresponding rotation phase a_{b} equal to −aₙ, which results in the use of identity bases.

A WTRU may use common Doppler domain bases with or without phase rotation on a certain beam, group of beams, layer, and/or a group of layers. The WTRU may use specific Doppler domain bases on other beam, group of beams, layer, and/or a group of layers with or without phase rotation. The WTRU may identify bases on other beams, layers and/or subbands.

A WTRU may report an indicator to indicate indices of beam and layers using common Doppler domain bases. In examples, a WTRU may use a bitmap of length L, where bit “1” may indicate a beam which uses common doppler domain bases and bit “0” indicates a beam with specific Doppler domain bases. Using

$$⌈ {log}_{2} ( \begin{matrix}L \\ L\_c\end{matrix} ) ⌉ bits ,$$

a WTRU may indicate of group of L_c beams which uses beam-specific bases and the WTRU may assume that the remaining beams use common bases, or vice versa. The WTRU may use a bitmap of length v, where bit “1” may indicate a layer which uses common doppler domain bases and bit “0” indicates a layer with specific Doppler domain bases. Using

$$⌈ {log}_{2} ( \begin{matrix}v \\ v\_c\end{matrix} ) ⌉ bits ,$$

a WTRU may Indicate of group of v_c layers which uses layer-specific bases and then the WTRU may assume that the remaining layer uses common bases, or vice versa.

A WTRU may determine the length of Doppler domain bases vector N based on the observed Doppler. In examples, a WTRU may use different Doppler thresholds to choose different values of N. The WTRU may choose smaller value of N for smaller Dopplers and/or the WTRU may choose larger N for higher Doppler.

A WTRU may indicate its preferred choice of N using an indicator in the UCI. The WTRU may receive the value of N from gNB. The WTRU and/or a gNB (e.g., both the WTRU and/or gNB) may determine the value of N based on the observed Doppler. In examples, different Doppler thresholds may be defined to determine different values of N.

A WTRU may determine the number of Doppler domain bases D as a function of the length of Doppler domain bases N and/or the number of PMI's reported per subband. The WTRU may determine the number of Doppler domain bases as D=pₛN/R, where p_s is a higher layer parameter. In examples, p_s may take different values (e.g., p_s=1/4, 1/2, 1/8 or 3/8, etc.).

A WTRU may determine the number of Doppler domain bases as a function of the length of Doppler domain bases (e.g., only as a function of the length of Doppler domain bases). The WTRU may determine D as D=p_sN, where p_s may be configured by higher layer parameters.

A WTRU may determine p_s as a function of Doppler. The WTRU may use different thresholds of Doppler to determine different values of p_s. For higher Doppler, the WTRU may use smaller value of p_s. The WTRU may use higher value of p_s for smaller Dopplers. A WTRU may report p_s in a CSI report as a high priority element. The WTRU may report p_s in the time-domain channel property (TDCP) report.

A WTRU may be configured with one or more different values for the number of Doppler domain bases D. In examples, a WTRU may be RRC configured with D=1, D=1, 2, and/or D=2, 4, etc.

A WTRU may be configured to report a CSI associated with one or more time slots occurring later than the slot wherein the WTRU measured the CSI. The CSI associated with a time slot later than the time slot wherein the WTRU performs the CSI measurement may be referred to as a predicted CSI. The time slot in which a WTRU measures a CSI may be interchangeably used with a previously measured time slot, a time slot including measurement RS, a time slot with CSI measurement, and/or a first time slot. The time slot associated with a CSI measured in an earlier time slot may be interchangeably used with a predicted time slot, a future time slot, a time slot with a CSI prediction, and/or a second time slot. A CSI measured in a first time slot and associated with a future time slot may be referred to as predicted CSI, CSI prediction, time-stamped CSI, and/or a CSI associated time stamp.

A WTRU may use D number of Doppler domain (DD) DFT bases vectors for DD compression of the PMI. The D number of DFT vectors may be needed at the gNB for decompression. The WTRU may or may not support a DD compression capability.

In examples, a WTRU may report and/or indicate the maximum number of DFT DD bases vectors that it supports. The a WTRU may report and/or indicate a maximum number of DFT DD bases vector D_max for DD compression in UCI. The maximum number of DFT DD bases information D_max may be per beam and/or per layer information.

A WTRU may receive a max value for D. In examples, a WTRU may receive D_1, where D_1 may be less than or equal to D_max. The WTRU may receive D_1 using an RRC configuration and/or a dynamic indication using MAC-CE and/or DCI.

A WTRU may receive the number of DD DFT bases vectors as part of an existing RRC configuration. The number of DD DFT bases vectors may be configured based on the number of beams, the number of layers, and/or one or more frequency domain compression parameters.

A WTRU may be configured with more than one table for parameters configuration of the codebook. The WTRU may receive an RRC configuration for using one or more tables. A new table may include information of the number of DD DFT bases vectors D, the number of beams, frequency domain compression parameters as a function of the total number of layers, and/or frequency domain compression parameter for defining a bound on the number of non-zero coefficients. The table may include different settings for, the number of beams, the number of DD DFT bases vectors, indication for defining the number of FD DFT vectors for frequency domain compression and/or an indication for defining a bound on the total number of non-zero coefficients.

The number of Doppler domain DFT bases vectors D may define the rate of compression of the PMI. Using a smaller value of D may result in higher compression of the PMI. Using a higher value of D may result in less compression of the PMI. Compression of the PMI may be a lossy compression. A smaller value of D may result in higher compression of the PMI, resulting in a smaller reporting overhead of the PMI but at the cost of accuracy of the reported PMI. A larger value of D may result in less compression of the PMI, resulting in a higher reporting overhead but a more accurate reporting of the PMI.

A WTRU may indicate its preferred configuration on the number of DD DFT vectors D and/or parameter configuration for FD compression based on service requirements. The WTRU may indicate its preferred configuration D and/or parameter configuration for FD compression based on service requirement, (e.g., URLLC and/or eMBB).

A WTRU may receive a preference on the number of DD DFT vectors D and/or parameter configuration for FD compression using a new and/or existing RRC configuration and/or a more dynamic indication using MAC-CE and/or DCI. The WTRU may receive an indication to discard the value of D from the RRC configuration.

A WTRU may determine the number of DD DFT vectors D based on the receive parameter configuration for FD compression. In examples, the WTRU may receive an RRC configuration for parameter configuration of the codebook. The configuration may include an indication of the number of beams, layers and/or frequency domain compression parameter for bounding the number of non-zero coefficients in the PMI. Based on the determined number of non-zero coefficients in one or more PMIs, a WTRU may choose a value for DD DFT vectors D for compression of future PMIs.

If the determined number of non-zero coefficients (NNZC) is less than a threshold (e.g., NZC is less than threshold_x), then the WTRU may use a value of DD DFT vectors equal to D_x. When the determined number of NZCs is equal to or greater than threshold_x and less than or equal to threshold_y, the WTRU may use a value of DD DFT vectors equal to D_y. When the determined number of NZCs for UCI is greater than threshold_y, a WTRU may use a value of DD DFT vectors equal to D_z. Therein, D_z may be smaller than or equal to D_y, and D_y may be smaller than or equal to D_x. Describing the association of number of NZC and DD DFT vectors D may be shown as:

$$NNZC < threshold\_x \qquad D = D\_x$$

$$threshold\_x \leq NNZC \leq threshold\_y \qquad D = D\_y$$

$$NNZC > threshold\_y \qquad D = D\_z$$

A WTRU may determine the number of NZCs in one or more PMI and/or a W2 matrix. Based on the determined number of NZCs, the WTRU may choose a configuration for DD DFT vectors D. The WTRU may choose a configuration of DD DFT vectors for DD compression of the current PMI and/or compression of the further PMI.

A WTRU may determine the number of DD DFT vectors D based on payload size of the UCI. The WTRU may choose its preferred configuration of D for DD compression based on the payload size of the UCI before compression. For example, if the UCI payload size is less than a threshold, a WTRU may use a larger value of D. If the UCI payload size for UCI is greater than a threshold, a WTRU may use a smaller value of D.

If the UCI payload size is less than a threshold, (e.g., UCI_payload is less than threshold_I), the WTRU may use a value of DD DFT vectors equal to D_I. When the UCI payload size is equal to or greater than threshold_I and less than or equal to threshold_II, a WTRU may use a value of DD DFT vectors equal to D_II.

When the UCI payload size is greater than threshold_II, a WTRU may use a value of DD DFT vectors equal to D_III, where D_III may be greater than or equal to D_II and D_II may be greater than or equal to D_I. Describing the association of UCI payload and DD DFT vectors D may be shown as:

$$UCI\_payload < threshold\_I \qquad D = D\_I$$

$$threshold\_I \leq UCI\_payload \leq threshold\_II \qquad D = D\_II$$

$$UCI\_payload > threshold\_II \qquad D = D\_III$$

The WTRU may determine the number of DD DFT vectors D based on the received grant for reporting the UCI. The WTRU may choose and may use its preferred configuration of D for DD compression based on the received grant for UCI reporting. For example, if the received grant for UCI reporting is less than a threshold, the WTRU may use a smaller value of D. If the received grant for UCI reporting is greater than a threshold, the WTRU may use a higher value of D.

In another example, if the received grant for UCI is less than a threshold, (e.g., grant_size is less than threshold_a), the WTRU may use a value of DD DFT vectors equal to D_a. When the received grant for UCI is equal to or greater than threshold_a and less than or equal to threshold_b, the WTRU may use a value of DD DFT vectors equal to D_b. When the received grant for UCI is greater than threshold_b, the WTRU may use a value of DD DFT vectors equal to D_c. Therein, D_c may be greater than or equal to D_b and D_b may be greater than or equal to D_a. Describing the association of UCI grant and DD DFT vectors D may be shown as:

$$UCI\_grant < threshold\_a \qquad D = D\_a$$

$$threshold\_a \leq UCI\_grant \leq threshold\_b \qquad D = D\_b$$

$$UCI\_grant > threshold\_b \qquad D = D\_c$$

In examples, a WTRU may determine the number of DD DFT vectors D based on priority values of the UCI. For example, the WTRU may choose and may use its preferred configuration of D for DD compression based on the on the priority value of the UCI. In an example, if the priority value of the UCI is less than a threshold, a WTRU may use a smaller value of D, and if the priority value of the UCI is greater than a threshold, a WTRU may use a higher value of D.

In examples, if the priority value of the UCI is less than a threshold, (e.g., priority_UCI is less than threshold_1), the WTRU may use a value of DD DFT vectors equal to D_1. When the priority value of the UCI is equal to or greater than threshold_1 and less than or equal to threshold_2, the WTRU may use a value of DD DFT vectors equal to D_2. When the priority value of the UCI is greater than threshold_2, the WTRU may use a value of DD DFT vectors equal to D_3, where D_1 may be greater than or equal to D_2 and D_2 may be greater than or equal to D_3. Describing the association of UCI priority and DD DFT vectors D may be illustrated as:

$$UCI\_priority < threshold\_a \qquad D = D\_ 1$$

$$threshold\_a \leq UCI\_priority \leq threshold\_b \qquad D = D\_ 2$$

$$UCI\_priority > threshold\_b \qquad D = D\_ 3$$

In examples, the WTRU may include an indication of its preferred choice of D in the UCI. Additionally or alternatively, the received/configured configurations of UCI payload size and/or UCI grant and/or priority value of the UCI and/or parameter configuration for FD compression may be used as an association of D between the WTRU and/or the gNB.

The WTRU may indicate UCI priority value in the UCI. The gNB may process the UCI priority value as an indication of the number of DD DFT vectors.

The WTRU may indicate the priority value of the UCI in the UCI. Upon reception of the UCI priority value, the gNB may use a common association between the WTRU and the gNB for determination of the number of DD bases vectors.

The time slot may be interchangeably used with symbol, reference symbol, time window, OFDM symbol, measurement resource, and/or measurement RS.

A confidence level (CL) may be defined, determined, and/or used to indicate a prediction accuracy of the CSI associated with a future time slot. For example, the WTRU may determine a CL for one or more estimated TDCPs based on channel conditions, WTRU architecture, receive antenna configuration, CSI reporting configuration, and/or system configuration. For example, the CL may be ranged from 0 to 1, wherein the value to 0 may imply that the predicted CSI accuracy is very low and the value to 1 may imply that the predicted CSI accuracy is very high, or vice versa. Additionally or alternatively, the CL may range from 1 to 10, and higher number may indicate higher confidence (e.g., higher accuracy).

A WTRU may determine a CL of a predicted CSI based on comparing the predicted CSI and actual CSI measurement in the future slot associated with the predicted CSI. The WTRU may determine the CL based on comparing an estimated TDCP with a measured TDCP.

A WTRU may determine a CL of a predicted CSI as a function of a plurality of factors, including but not limited to: channel conditions (e.g., Doppler frequency, Doppler shift, Delay spread, and/or signal to noise ratio (SNR), etc.), receiver architecture (e.g., time/frequency sync error level and/or receiver sensitivity, etc.), Rx antenna configuration (e.g., number of antennas, and/or antenna coherency level, etc.), CSI reporting type/configuration (e.g., codebook type, reporting quantity, reporting periodicity, reporting type, and/or uplink resource for reporting, etc.), and/or system configuration (e.g., subcarrier spacing, frequency band, carrier frequency, bandwidth, and/or duplex mode, etc.). Confidence level may be interchangeably used with prediction accuracy level, reliability level, prediction confidence level, and/or prediction level.

A CL may be indicated together with a TDCP report, since the accuracy of the TDCP report may be affected by one or more of the above factors. In examples, a WTRU may report the measured TDCP. At the same time, the WTRU may indicate the CL associated to the TDCP measurement.

A CL may be indicated together with predicted CSI. For example, when a WTRU reports CSI associated with a future time slot, the WTRU may report CL corresponding to the predicted CSI.

When one or more CSI reporting quantities are ready to be reported, a CL may be associated with all CSI reporting quantities measured in the same slot. Additionally or alternatively, a CL may be associated with a specific CSI reporting quantity (e.g., PMI). When a WTRU reports one or more CSI reportings measured in one or more time slots, a CL may be reported per time slot. The reported CL may be associated with all CSI reporting quantities measured in the same time slot. When a WTRU reports one or more CSI reportings measured in one or more measurement resources (e.g., CSI-RS, synchronized signal block (SSB), and/or tracking reference signals (TRS)), a CL may be reported per measurement resource. The reported CL may be associated with all CSI reporting quantities measured with the same measurement resource (e.g., or measurement resource set).

A CL may be implicitly based on the timing offset between the first time slot (e.g., measured time slot) and/or the second time slot (e.g., future time slot associated with the predicted CSI).

The CL may be determined as a function of the time offset between measured time slot and the future time slot associated with the predicted slot. For example, a WTRU may perform CSI measurement in slot #n and the WTRU predicts a CSI for the slot #n+K, where K may be referred to as the time offset. The CL may be lower when K becomes large.

At a given time offset (e.g., K), the CL may be further determined based on one or more of channel conditions, receiver architecture, WTRU capability, Rx antenna configuration, and/or CSI reporting type and/or configuration.

When the CL determined for a predicted CSI and/or an estimated TDCP is below a threshold, the WTRU may drop the associated reporting (e.g., CSI and/or TDCP reporting), transmit null information when the UCI is multiplexed with data (e.g., PUSCH), de-prioritize the associated CSI, and/or trigger reporting of the event. The threshold may be configured per CSI reporting setting/configuration. The threshold may be determined based on CSI reporting type and/or configuration.

Regarding CSI inclusion and/or omission, Equation (1) may be used to assign a priority value to the NZCs of a W_2 matrix. For example, Equation (1) may be used to assign priority values of the subband amplitude coefficients on each layer, beam/polarization, and/or DFT vector. Similar priority values may be assigned to the associated phase coefficients of the amplitude coefficients. The K_NZ NNZCs, K_NZ/2 NNZCs, and/or the associated bits of the bitmap used for indication of the NZCs indices may be included in the second highest reporting priority part of a CSI report, commonly known as part 2 of a CSI report. Within part 2 of the CSI report, the K_NZ/2 NNZCs out of K_NZ NNZCs may be placed in the second highest reporting priority part of CSI part 2, commonly known as group 1. In Equation (1), v is the number of layers l=1, . . . , v, L is the number of beams i=0, . . . , 2L−1, Mᵥ is the number of DFT vectors for frequency domain compression f=0, . . . , Mᵥ−1, N3 is the number of subbands,

$${n}_{3 , l}^{( f )} ∈ \{ 0 , … , {N}_{3} - 1 \}$$

is the subband index of a NZC on layer l, and DFT vector f.

$$P ( l , i , f ) = 2 \times L \times v \times min ( 2 \times {n}_{3 , l}^{( f )} , 2 \times ( {N}_{3} - {n}_{3 , l}^{( f )} ) ) + v \times i + l \qquad Equation ( 1 )$$

Equation (1) may be modified and used by a WTRU to assign priority values to CSIs for the purpose of CSI omission in a high Doppler and/or high velocity scenario. For example, an additional parameter may be added to Equation 1 to prioritize CSI omission on polarization and/or beam and DFT vector and/or DD basis vector. For instance, Equation (1) may be modified as shown in Equation (2), where an additional parameter ρ₁ (e.g., which may be represented as ρ_1) is introduced.

$$P ( l , i , f , d ) = 2 \times L \times v \times min ( 2 \times {n}_{3 , l}^{( f )} , 2 \times ( {N}_{3} - {n}_{3 , l}^{( f )} ) ) \times {ρ}_{1} + v \times i + l \qquad Equation ( 2 )$$

Where ρ₁ may be used to map and assign a value to the D Doppler-domain basis vectors to prioritize UCI omission on a certain Doppler domain basis vector.

The WTRU may assign a value to ρ_1 for each Doppler-domain basis vectors for the purpose of CSI omission on the Doppler-domain basis vector. The WTRU may assign a smaller value to ρ_1 for a given Doppler-domain basis to de-prioritize CSI omission on the Doppler-domain basis vector and a higher value to ρ_1 for a given Doppler-domain basis to prioritize CSI omission on the Doppler-domain basis vectors.

In examples, ρ_1 may take a value in the range ┌ρ(1_initial), ρ_1_(1_D)┐. Parameter ρ_1 may take a value in the range 1, . . . . D, where 1<D. A smaller value of ρ_1 (e.g., ρ_1=1) may be assigned to a Doppler-domain basis vector for de-prioritizing CSI omission on the Doppler-domain basis vector. A higher value of ρ_1 (e.g., ρ_1=D) may be assigned to a Doppler-domain basis vector for prioritizing CSI omission on the Doppler-domain basis vectors.

The WTRU may assign values of ρ_1 to the Doppler-domain basis vectors based on a certain rule to prioritize CSI omission on certain Doppler-domain basis vectors. In examples, the values of ρ_1 to the Doppler-domain basis vectors may be assigned according to the rule ρ_1=d, where d=1, . . . . D. Such mapping of the Doppler-domain basis vectors may prioritize omitting CSI on the Doppler-domain basis vectors according to the order D, D−1, D−2, . . . 1.

In examples, let d=1, . . . d_s, . . . . D be the indices of the Doppler-domain basis vectors and d_s be the index of the Doppler-domain basis vector with the strongest coefficient. A WTRU may assign ρ_1 values of 1, . . . . D−d_s to Doppler-domain basis vectors with indices d_s, . . . . D and ρ_1 values of D−d_s+1, . . . . D to Doppler-domain basis vectors with indices 1, . . . d_s−1.

The WTRU may re-order indices of the Doppler domain basis vectors so that the Doppler domain basis vector with the strongest coefficient is indexed as the first Doppler-domain basis vector. The resulting Doppler-domain basis vectors may then be indexed as ┌d_s, . . . , D, 1, . . . d_s−1┐. For example, the WTRU may assign:
a ρ_1 value of ρ_1=1 to the Doppler-domain basis vector with the strongest coefficient;
a value of ρ_1=2 to Doppler-domain basis vector D;
a value of ρ_1=3 to Doppler-domain basis vector 2;
a value of ρ_1=4 to the Doppler-domain basis vector D−1;
a value of ρ_1=5 to the Doppler-domain basis vector 3; and
a value of ρ_1=6 to the Doppler-domain basis vector D−2, and so on.

Parameter ρ₁ may be defined as

$${ρ}_{1} = min ( 2 \times {n}_{l}^{( d )} , 2 \times ( N - {n}_{l}^{( d )} ) ) ,$$

where N is the length of Doppler domain bases vector, D is the number of Doppler domain bases d=0, . . . , D−1, n_l\hat{ }(d))={0, . . . , N−1} is the index of a NZC on layer I and Doppler domain bases D pertaining to some CSI-RS in the CSI-RS burst. When one strongest coefficient is reported for M<N number of component precoders, then n_l\hat{ }(d\hat{ }′))∈{0, . . . , M−1}, and d\hat{ }′=0, . . . , D\hat{ }′, where D\hat{ }′<D. When one strongest coefficient is reported for each W_2 matrix, then ρ_1=1. Based on Equation (2), the WTRU may include certain CSI elements in a CSI report as described herein.

Regarding non-zero coefficients (NZCs), for a CSI report, carrying multiple component precoders, a WTRU may include K_NZ/x number of subband amplitude coefficient out of K_NZ number of coefficients in a CSI report as high priority coefficients. The WTRU may determine the value of x based on the observed Doppler. The WTRU may use different values of x based on different Doppler thresholds. In examples, the WTRU may use higher value of x if the associated Doppler is higher, or vice versa.

The K_NZ/x NNZCs included in the CSI report as high priority elements may be determined based on its priority value assigned based on Equation (2). A WTRU may include the first K_NZ/x NNZC with smallest priority values as high priority elements. The WTRU may include the corresponding K_NZ/x number of phase coefficients of the high priority amplitude coefficients in the CSI report. The WTRU may include the corresponding bits of the bitmap which indicates the layer, beam/polarization, DFT vector, and Doppler bases as high priority elements in a CSI report.

A WTRU may include the remaining K_NZ-K_NZ/x number of amplitude and/or phase coefficients as low priority elements in a CSI report.

A WTRU may prioritize reporting of the high priority elements of a CSI report over the low priority elements of the same or different CSI report. Moreover, the WTRU may prioritize reporting of the low priority elements of a CSI report CSI_n over the high priority elements of a CSI report CSI_n+1.

A WTRU may add another parameter (e.g., PMI_TYPE) to Equation (2) to prioritize or deprioritize the NZCs of a CSI report based on their relation to a component precoder over the NZCs of another CSI report. In examples, the parameter PMI_TYPE may take values from 0 to 1, wherein value 0 implies higher priority and value 1 implies lower priority. Additionally or alternatively, PMI_TYPE may take values from 1 to 10, where value 1 implies higher priority and higher values imply lower priority.

A WTRU may assign PMI_TYPE a value to prioritize the high priority and/or low priority NZCs of a legacy PMI or any other component PMI over the high priority and/or low priority NZCs of another legacy PMI or component PMI.

A WTRU may report one strongest coefficient for all component precoders, one strongest coefficient for a group of component precoders, and/or one strongest coefficient for each component precoder.

A WTRU may include the beam/polarization index of one strongest coefficient for all component precoders as a high priority element in part 2 of a CSI report carrying the SD and FD bases for all the component precoders.

A WTRU may include the beam/polarization index, DFT vector index, W_2 index, and/or Doppler domain bases index of one strongest coefficient for multiple component precoders in a CSI report carrying the SD and FD bases of the multiple component precoders in part 2 of a CSI report as a higher priority element.

As to CSI inclusion/omission based on Doppler, the observed Doppler on a given beam/polarization and layer may be defined and used as a priority value for NZCs on the corresponding beam/polarization and layer. Priority value assignment to a NZCs may be a function of the amplitude level of the NZCs. A WTRU may assign different priorities to NZCs whose beams/polarizations experience the same Doppler. The priority value assignment as a function of Doppler as provided by Equation (3):

$$P ( i , l , f , d ) = {z}_{i , l , f , d} \qquad Equation ( 3 )$$

where Z_{l,i,f,d} is a value assigned to each NZC based on the observed Doppler. The amplitude level of the NZC. Z_{l,i,f,d} may take values from 0 to 1, where value 0 implies higher priority and value 1 implies lower priority. Additionally or alternatively, Z_{l,i,f,d} may take values from 1 to 10, where value 1 may imply higher priority and higher values of Z_{l,i,f,d} may imply lower priority.

A WTRU may assign z_{i,l,f,d}=0 to a NZC with the highest amplitude level on DFT vector fand Doppler domain bases vector d, whose beam i and layer I experience the highest Doppler. The WTRU may assign z_{i,l,f,d}=1 to an NZC with the smallest amplitude level whose beam i, and layer l, experiences the smallest Doppler. The WTRU may assign z_{i,l,f,d}=u to a NZC_1 whose beam/polarization and layer experience a smaller doppler as compared to a NZC_2 with z_{i,t,f,d}=y, where u≤y and where the amplitude level of NZC_1 is less than the amplitude level of NZC_2. The WTRU may use an indicator to indicate the beam/polarization, layer, DFT vector, and/or Doppler domain bases of all NZCs with their associated z_{i,l,f,d} value greater than a threshold, where the threshold may be obtained as a function of Doppler and/or amplitude level. The WTRU may prioritize reporting the high priority NZCs over the low priority NZCs within a CSI report. The WTRU may prioritize the low priority elements of a CSI report CSI_n over the high priority elements of a CSI report CSI_n+1. The WTRU may assign z_{i,l,f,d} a value to prioritize the high priority and/or low priority NZCs of a legacy PMI or any other component PMI over the high priority and/or low priority NZCs of another legacy PMI or component PMI.

As to predicted CSI omission based on confidence level of prediction, a CL of prediction may be defined and used to assign priority values of to each coefficient of the predicted CSI. A CL of prediction on layer l, beam/polarization i, and at some future time instant t may be expressed as ρ₃(i, l, t). Coefficients of the predicted CSI may be assigned priority values, for example, as shown in Equation (4):

$$P ( l , i , t ) = 1 / {ρ}_{3} ( i , I , t ) \qquad Equation ( 4 )$$

where p(l,i,t) is the priority level assigned to the predicted channel/CSI on layer, beam/polarization i and future time instant t.

A WTRU may include predicted CSI elements with smaller values of P(i, l, t) values for all layers, beams/polarization and future time instances of prediction as high priority elements in a CSI report and may include the predicted CSI elements with higher values of P(i, l, t) for all beams, layers and future time instances of prediction as low priority elements in a CSI report, for example, using Equation (4).

A WTRU may use an indicator to report the layer, beam/polarization and future time instant indices of the predicted CSIs included in a CSI report as high priority elements. In examples, a WTRU may use a bitmap of length 2×L×v×t_{f} bits for t_{f} number of future time instances as an indicator to indicate the layer, beam/polarization and future time indices of the predicted CSIs included in a CSI report as high priority elements. In examples, a WTRU may use

$$⌈ {log}_{2} ( \begin{matrix}2 Lvt \\ {K}_{t}\end{matrix} ) ⌉ bits$$

as an indication of layer, beam/polarization and future time indices of K_t number of high priority elements included in a CSI report.

A WTRU may use a second indicator to report the layer, beam/polarization and future time instant index of the predicted CSIs included in a CSI report as low priority elements. In examples, the WTRU may use a bitmap of length 2×L×v×t_{f} bits for t_{f} number of future time instances as an indicator to indicate the layer, beam/polarization, and future time indices of the predicted CSIs included in a CSI report as low priority elements. The WTRU may use

$$⌈ {log}_{2} ( \begin{matrix}2 Lvt \\ {K}_{r}\end{matrix} ) ⌉ bits$$

as an indication of layer, beam/polarization, and future time indices of K_r number of high priority elements included in a CSI report.

A WTRU may use an indicator to indicate the number of Kₜ high priority elements in a CSI report as a high priority element. In examples, a WTRU may use ┌log₂ K_{T}┐ bits in a CSI report to indicate the number of high priority elements in a CSI report. The number of high priority predicted NZCs may be upper bounded as Kₜ≤K_{T}.

A WTRU may use an indicator (e.g., another indicator) to indicate the Kᵣ number of low priority elements in a CSI report report as a high priority element. In examples, the WTRU may use ┌log₂K_{R}┐ bits in a CSI report to indicate the number of low priority elements in a CSI report. The number of low priority predicted NZCs may be upper bounded as Kᵣ≤K_{R}.

A WTRU may prioritize reporting the high priority predicted CSIs over the low priority predicted CSIs within a CSI report. The WTRU may prioritize the low priority of the predicted CSIs in a CSI report. The WTRU may prioritize reporting the CSI_n over the high priority predicted CSIs of a CSI report CSI_n+1. The WTRU may add an additional value to Equation (4) to prioritize the high priority and/or low priority predicted CSIs of a legacy PMI over the high priority predicted CSIs of another legacy PMI. The WTRU may add an additional value to Equation (4) to prioritize the high priority and/or low priority predicted CSIs of one component precoder over the high priority predicted CSIs of another component precoder.

A WTRU may prioritize one CSI report over another CSI report based on its assigned priority values given in Equation (4), for example, as provided by Equation (5):

$${Pri}_{iCSI} ( y , k , c , s ) = 2 {N}_{cells} {M}_{s} y + {N}_{cells} {M}_{s} k + {M}_{s} c + s \qquad Equation ( 5 )$$

Where the value of y depends on aperiodic CSI, semi-persistent CSI, and/or periodic CSI reports carried on PUCCH and/or PUSCH; k depends on CSI reports carrying L1-reference signal received power (RSRP) and/or L1-SINR, c is the serving cell index, N_cells is maxNrofServingCells, s is reportConfigID, and M_s is the value of the maxNrofCSI-ReportConfigurations. The WTRU may modify Equation (2) as follows to generate Equation (6):

$${Pri}_{iCSI} ( y , k , c , s , {ρ}_{2} ) = 2 {N}_{cells} {M}_{s} y + {N}_{cells} {M}_{s} k + {M}_{s} c + s + {ρ}_{2} \qquad Equation ( 6 )$$

Where ρ₂ may be defined, used, and take a value between 0 to 1, wherein 0 implies higher priority and 1 implies lower priority. Additionally or alternatively, ρ₂ may take values between 1 to 10, wherein 1 implies higher priority and higher numbers imply lower priority. In examples, ρ₂ may be set to 0 and additional values may be assigned to the variable k. Hereinafter, the CSI prioritization explained using ρ₂ may equally be performed using the variable k.

A CSI report may include the contents of TDCP. The WTRU may include a TDCP estimated using one or more delays in a CSI report. The WTRU may prioritize a CSI report with TDCP contents: over another CSI report with no TDCP. The WTRU may prioritize a CSI report with TDCP contents; estimated using two or more delays over a CSI report with TDCP contents estimated using one delays. The WTRU may prioritize a CSI report with TDCP contents; estimated using a higher number of delays over a CSI report with TDCP contents estimated using a smaller number of delays. The WTRU may prioritize a CSI report with TDCP contents over another CSI report by assigning a smaller value of ρ_2 to CSI reports with TDCP contents as compared to CSI reports with no TDCP contents.

The WTRU may assume a TDCP report as a standalone report. The WTRU may prioritize a TDCP report: over a CSI report. The WTRU may prioritize a TDCP report; estimated using two delays over a TDCP report estimated using one delay. The WTRU may prioritize a TDCP report; estimated using a higher number of delays over a TDCP report using a smaller number of delays. The WTRU may prioritize a TDCP report over a CSI report by assigning a smaller value of ρ_2 to the TDCP report and a higher value of ρ_2 to the CSI report. Additionally or alternatively, the WTRU may prioritize a TDCP report over a CSI report using the variable k in Equation (1). In examples, the WTRU may assign a value of k=0 to a TDCP report estimated using more than one delays, k=1 to a TDCP report estimated using one delay; k=2 for CSI reports carrying L1-RSRP or L1-SINR; and/or k=3 for CSI reports not carrying L1-RSRP and/or L1-SINR.

The WTRU may assign a value of ρ₂ to a CSI report based on the type of component precoder it carries. In examples, the WTRU may assign a value of 0 to a CSI report carrying legacy PMIa value of a value of ρ₂=0.1 to a CSI report carrying component precoder PMI_5, a value of ρ₂=0.2 to a CSI report carrying component precoder PMI_4, a value of ρ₂=0.3 to a CSI report carrying component precoder PMI_1, a value of ρ₂=0.4 to a CSI report carrying component precoder PMI_6, a value of ρ₂=0.5 to a CSI report carrying component precoder PMI_3 and/or a value of ρ₂=0.6 to a CSI report carrying component precoder PMI_2. The WTRU may assign smaller value of ρ₂ to a CSI report carrying multiple component precoders, e.g., ρ=0.1 to a CSI report carrying N_1 number of component precoders PMI_2 and a value of ρ₂=0.2 to a CSI report carrying N_2 number of component precoders PMI_2 if N_1 is greater than N_2.

The WTRU may drop a CSI report fully or partially with the highest priority value. The WTRU may adjust the value of ρ₂ to prioritize a CSI report with smaller priority over another CSI report with higher priority based on the type of PMI the CSI report is carrying. In examples, the WTRU may adjust ρ₂ to prioritize CSI report CSI_n over another CSI report CSI_m, where CSI_m has higher priority than CSI_n; CSI_m may be carrying multiple PMI_2s; and/or CSI_n may be carrying PMI_1, PMI_3, PMI_4, PMI_5, and/or PMI_6. In examples, the WTRU may adjust ρ₂ to prioritize any CSI report carrying SD, FD and/or Doppler domain bases over another CSI report carrying (e.g., only carrying) co-phasing coefficients. Therefore, the CSI report may be transmitted with a higher priority as compared to other CSI reports.

Regarding predicted CSI prioritization based on CL of prediction, a CSI report may be configured to carry both predicted CSI and/or actual CSI, wherein actual CSI is the CSI measured via CSI-RS. The WTRU may assign a CSI report a priority value based on the CL of prediction given by the following Equation (7):

$${Pri}_{iCSI} ( y , k , c , s , {ρ}_{2} , {ρ}_{3} ) = 2 {N}_{cells} {M}_{s} y + {N}_{cells} {M}_{s} k + {M}_{s} c + s + {ρ}_{2} + {\sum }_{i = 0}^{2 L - 1} {\sum }_{l = 0}^{v - 1} {\sum }_{∀ ( {t}^{′} ∈ t )} 1 / {ρ}_{3} ( i , I , {t}^{′} ) \qquad Equation ( 7 )$$

Where t′∈t indicates all future time instances of prediction, whose predicted CSIs are included in the i_th CSI report, and ρ₃(i, I, t′) is the CL of prediction at future time instances t′. An i_th CSI report may have higher priority over CSI report i+1 if the associated Pri_{iCSI}(y, k, c, s, ρ₂, ρ₃) value is higher than Pri_{(i+1)CSI}(y, k, c, s, ρ₂, ρ₃).

The WTRU may not send a CSI report with the highest priority value. The WTRU may collect one or more predicted CSIs with the highest confidence level of prediction over all future time instances t, beams i, and/or layers l, in a first CSI report and one or more predicted CSIs with second highest confidence level of prediction over all future time instances t, beams i, and/or layers I in a second CSI report. Then, the first CSI report may have a higher priority over the second CSI report.

The WTRU may use an indicator to indicate layer, beam/polarization, and/or time instant of the predicted CSIs included in the CSI report. In examples, the WTRU may use a bitmap of length 2Lvt whose bit value 1 may indicate that the predicted CSI at layer l, beam i and/or time instant t are included in the CSI report. Further, the WTRU may use a bitmap of length 2Lvt whose bit value 0 may indicate that the predicted CSI at layer l, beam i and/or time instant t are not included in the CSI report.

The WTRU may use an indicator with two sub-indicators to indicate the presence and/or absence of predicted CSIs in a given CSI report. The indicator may further indicate the beam indices i, layer indices l, and/or time instances t. In examples, a WTRU may use a first bitmap of length t. Bitmap value 1 of the bitmap may indicate the presence and time index of predicted CSIs in a CSI report and/or bit value 0 may indicate the absence of predicted CSIs at a given time index in a CSI report, or vice versa. For each bit value 1 in the first bitmap, the WTRU may use a second bitmap of length 2Lv to indicate the layer and beam/polarization indices of the predicted CSI in each CSI report. The WTRU may include the indicators for indication of layer, beam/polarization, layer and/or future time indices as a high priority element in the CSI report carrying the associated predicted CSIs. The WTRU may adjust the priority value of a CSI report to prioritize a CSI report carrying actual CSI over a CSI report carrying predicted CSI. The WTRU may adjust the priority value of a CSI report to prioritize a CSI report carrying actual SD, FD, and/or Doppler domain bases over another report carrying (e.g. only carrying) co-phasing coefficients. A CSI report may be configured to carry (e.g. only carry) predicted CSI. The WTRU may assign a priority value to such a CSI report based on the confidence level of prediction, for example, as provided by Equation 8:

$${Pri}_{iCSI} ( l , i , {ρ}_{3} ) = {\sum }_{i = 0}^{2 L - 1} {\sum }_{l = 0}^{v - 1} {\sum }_{∀ ( {t}^{′} ∈ t )} 1 / {ρ}_{3} ( i , I , {t}^{′} ) \qquad Equation ( 8 )$$

The WTRU procedures and signaling mentioned above for a CSI report carrying predicted CSI and actual CSI may be used for a CSI report carrying (e.g., only carrying) the predicted CSI.

CSI reporting content may switch as a function of configuration or TDCP. The WTRU may support more than one CSI reporting method, and a WTRU may be configured or indicated to generate CSI according to one CSI reporting method. In some examples, a CSI reporting setting may be configured with a setting for high Doppler CSI reporting mode, highDopplerReporting, and multiple sets of CSI reporting parameters (e.g., timing, codebook, etc.).

The WTRU may determine one set of CSI reporting parameters as a function of the highDopplerReporting value. A reporting mode may be set to Legacy mode, wherein the WTRU uses Rel-17 reporting methodology without additional enhancements to report Rel-17 Type-II CSI. A reporting mode may be set to EnhancedW2 mode, wherein the WTRU may indicate that its report includes multiple W_2s linked to a single W_1 and/or W_f. A reporting mode may be set to DopplerCompression mode, where the WTRU may report feedback related to Doppler domain compression (e.g., time domain basis and coefficients such as DFT and/or Doppler basis).

The WTRU may receive a CSI reporting configuration, and based on the reporting mode, may determine the contents to include in the UCI for a high Doppler CSI report. In examples, a WTRU may determine its preferred reporting method. The WTRU may include explicit bits in the UCI to indicate the selected reporting mode (e.g., highDopplerReporting). For example, a bit string of 2 bits may map to one of the reporting modes identified above. The WTRU may include different types of contents in the UCI report as a function of the reporting mode. The network may receive the UCI and may determine the content based on the explicit bit indication.

The WTRU may determine the reporting mode based on preconfigured thresholds on some codebook parameters such as N₄ and/or TDCP parameters. When N=1, a WTRU may use Legacy reporting mode. When 1<N<Nₐ, a WTRU may use EnhancedW2 reporting mode, when N≥Nₐ, a WTRU may use DopplerCompression as the reporting mode.

For example, if a CSI reporting method is configured with N4>threshold, then the WTRU may report CSI contents for reporting mode 1. If N4<threshold, then the WTRU may report CSI contents for reporting mode 2. Additionally or alternatively, if a CSI reports a parameter in the TDCP (e.g., measured Doppler) threshold, then the WTRU may report CSI contents for reporting mode 1. If a CSI reports a parameter less than threshold, then the WTRU may report CSI contents for reporting mode 2.

The network may interpret the CSI contents of the high Doppler CSI report as a function of the parameters included in the TDCP report. For example, the WTRU may first transmit a TDCP report that includes its Doppler measurement, followed by the CSI report. The network may determine the reporting mode for the CSI report to be Legacy if the Doppler is small or N=1. The network may determine reporting mode for the CSI report to be EnhancedW2 if 1<N<Nₐ, or medium Doppler. The network may determine reporting mode for the CSI report to be DopplerCompression if N>Nₐ or for a higher Doppler.

The WTRU may receive a configuration including a timer value. For example, the timer t1 may determine that all CSI reports transmitted by the WTRU within t1 seconds after a TDCP report follow one of the reporting modes (e.g. EnhancedW2), and after t1 seconds switch to another reporting mode (e.g., Legacy). The WTRU may include different contents in the UCI when transmitting within t1 seconds and/or include a different set of parameters in the UCI after the t1 seconds.

The WTRU configured with multiple CSI reporting configurations may have each CSI reporting configuration associated to a TDCP report configuration. The WTRU may determine the contents for each CSI reporting configuration as a function of the associated TDCP report configuration.

Time domain compression and/or prediction may be performed by the WTRU and/or at the gNB side. In examples, the WTRU may be capable of compression and/or prediction but a gNB may have better capabilities to do more accurate prediction. For example, the WTRU may perform measurements based on downlink (DL) RS, and the gNB may perform measurements based on uplink (UL) RS. the UL RS may occur more frequently and/or more recently than the DL. In examples, the WTRU may have (e.g., only have) basic capabilities to report prediction on short time frames whereas a gNB may have more processing to produce predictions on longer time frames.

The WTRU may indicate time domain compression and prediction parameters, and a measure of quality of its compression and/or prediction. The measure quality may consist of one or more of a channel measurement (e.g., the mean squared error (MSE) of the channel estimates, measure of confidence output from estimation algorithm, and/or type of estimation algorithm), the number of samples used for the prediction, the maximum prediction length within a threshold (e.g. with an MSE less than threshold, and/or confidence interval), signal quality measurement (e.g., RSRP, received signal strength indicator (RSSI), SNR), and/or beam index (e.g., panel index, reference signal index such as CSI-RS resource indicator (CRI), synchronization signal physical block channel block resource indicator (SSBRI), and/or satellite radio interface (SRI)).

A network may use the quality measure to determine the reliability of the WTRU's prediction. A gNB may adjust the WTRU's precoding selection with its own determination depending on the WTRU's capability.

The WTRU may receive a configuration for a high doppler CSI report which may include one of the measures of quality as part of the configuration. That WTRU may generate enhanced high doppler CSI compression and/or prediction contents only if the WTRU's measurements are above a measure of quality threshold. For example, the WTRU may receive a configuration with an MSE threshold, and the WTRU may generate a measurement and/or prediction which the WTRU determines yields an MSE above the threshold. The WTRU may thus not include prediction-related parameters in the CSI and only include CSI according to a Legacy reporting type.

Additionally or alternatively, a high doppler CSI reporting mode may be configured with different sets of parameters for different prediction methods (e.g., one set of parameters for short prediction lengths less than a threshold in seconds, and another set of parameters for long prediction lengths). Each set of parameters may be associated to an index (e.g., Doppler Resource Index (DRI)). The WTRU may receive a configuration with each set of parameters associated to a DRI. The WTRU may determine to use a first set of parameters if one of the configured measure(s) of quality is above a threshold, and may determine to use a second set of parameters if the configured measure(s) of quality is less than a threshold. For example, a first set may be for predictions of 1 seconds, and/or a second set for predictions of 5 seconds. The WTRU may calculate an MSE greater than threshold when generating predictions of 5 seconds, while it may calculate an MSE less than threshold when generating predictions of 1 seconds. The WTRU may include in its CSI report the CSI parameter set for the prediction of 1 seconds, and/or its associated DRI to indicate to the gNB of its selection. A DRI may be associated to a set of parameters without a prediction. If the WTRU selects the DRI associated to a set of parameters without a prediction, the WTRU may include legacy CSI components in the CSI report along with the DRI. The gNB may perform the prediction entirely.

A WTRU may determine to report a CQI which may be associated with one or more time slots other than the slot in which the WTRU measures the CQI. A CQI intended for a future slot other than the slot in which a WTRU measure the CQI may be referred to as a predicted CQI.

In examples, the WTRU may receive one or more measurement RSs on one or more layers to measure CQIs for one or more layers and/or for one or more future time slots. The measured CQI may be applicable at one or more future time slots. The future time duration in which the measured and/or predicted CQI may be applicable is an integer multiple of the time duration associated with a component PMI. The integer I may be termed as accuracy of CQI prediction duration indication.

The accuracy of CQI prediction duration indication may take a value from zero to the total number of component precoders or the total number of W_2 matrices. A CQI prediction duration indication equal to zero may imply that the measured and/or predicted CQI may not apply to any future time slots. The accuracy of CQI prediction duration indication equal to zero may imply that the measured and/or predicted CQI may only apply to the time slot in which the CQI is measured and/or predicted.

The accuracy of CQI prediction duration indication equal to the total number of component preorders may imply that the measured and/or predicted CQI may apply to a future time duration equal to the time duration of the entire PMI.

The WTRU may determine accuracy of CQI prediction duration (I) based on comparing the predicted CQI and actual CQI measurement in the future slot associated with the predicted CQI.

Moreover, the WTRU may determine accuracy of CQI prediction duration as a function of one or more of the following: channel conditions (e.g., Doppler frequency, Doppler shift, Delay spread, and/or SNR, etc.), receiver architecture (e.g., time/frequency sync error level and/or receiver sensitivity, etc.), Rx antenna configuration (e.g., number of antennas and/or antenna coherency level, etc.), CSI reporting type and/or configuration (e.g., codebook type, reporting quantity, reporting periodicity, reporting type, and/or uplink resource for reporting, etc.), system configuration (e.g., subcarrier spacing, frequency band, carrier frequency, bandwidth, and/or duplex mode, etc.), and/or accuracy of CQI prediction duration may be indicated together with a TDCP report. Additionally or alternatively, the WTRU may indicate the accuracy of CQI prediction duration together with the measured and/or predicted CSI associated with a future time slot.

When the accuracy of CQI prediction duration is below a threshold, the WTRU may perform one or more of the following actions: stop reporting predicted CQI for future time slots; report measured CQI for one or more component precoders and/or W_2 matrices; and/or assign a value to accuracy of CQI prediction duration (I) for a future time slot based on CSI confidence level of prediction for that time slot.

In examples, the WTRU may report one or more actual and/or predicted CQIs for the time duration associated with: the actual and/or predicted PMI; the time duration associated with the N_4 component precoders; and/or the time duration associated with the N_4 W_2 matrices.

The WTRU may report the number of actual and/or predicted CQIs for the time duration associated with the actual and/or predicted PMI.

The WTRU may report the time slot locations for application of each actual and/or predicted CQI. In examples, a WTRU may report a first actual and/or predicted CQI (e.g., CQI_1) and a second actual and/or predicted CQI (e.g., CQI_2) for the time duration association with the actual and/or predicted PMI. The WTRU may indicate time slot locations for application of the first actual and/or predicted CQI and time slot locations for application of the second actual and/or predicted CQI. The WTRU may indicate the slot index, symbol index, the number of slots, and/or the number of symbols for application of the first actual and/or predicted CQI. The WTRU may indicate the slot index, symbol index, the number of slots, and/or the number of symbols for application of the second actual and/or predicted CQI.

The WTRU may indicate the time slot location for application of each actual and/or predicted CQI, the number of actual and/or predicted CQIs for the time duration associated with the actual and/or predicted PMI in the UCI. Time slot location for application of each predicted CQI may be determined based on the CL of prediction.

In examples, the WTRU may report one or more differential CQIs relative to the CQI of the component precoder with the strongest amplitude coefficient among all component precoders. A component precoder W_2(n) may have the strongest amplitude coefficient. The CQI associated with the component precoder W_2(n) may be CQI(n). The WTRU may perform one or more of the following: report CQI(n) for component precoder W_2(n), report CQI(n)-CQI(n+k) for component precoder W_2(n+k), report CQI(n)-CQI(n−k) for component precoder W_2(n−k), and/or report CQI(n−k) for component precoders W_2(n), W_2(n−1), . . . . W_2 (n−k).

In examples, the WTRU may report one CQI, where the reported CQI is an average of the CQIs intended for one or more component precoders. The WTRU may report an average CQI of all the actual and/or predicted CQIs, report the maximum actual and/or predicted CQI, and/or report the minimum actual and/or predicted CQI.

Hereinafter, a frequency-unit may refer to a resource block, a subband and/or a bandwidth part (BWP). A time-unit may refer to a symbol, slot, frame and/or sub-frame.

The WTRU may be configured and/or determined to report one or more CQIs which may be associated with one or more time-units and/or frequency-units other than the time-units the WTRU use to measure the CQIs. The WTRU may be additionally configured, determined, and/or indicated by RRC, DCI, or MAC-CE to report the measured CQIs using one or another method for the purpose of reducing CQI reporting overhead or for the purpose of reporting accurate CQIs. In examples, the WTRU may be configured to report the measured CQIs using method-1 and/or method-2. CQIs reporting using method-1 may result in reporting accurate CQI and reporting CQIs using method-2 may result in smaller feedback overhead.

The WTRU may determine its preferred method for reporting CQIs and the reported CQI based on the CQI variation across certain time-units and/or across certain frequency-units. In examples, in a given time unit, the WTRU may determine 0, 1, or more CQIs in each frequency-unit based on the variation of CQI across the frequency-units. The WTRU may determine a differential CQI for the frequency-units x+1, . . . , x+ψ, based on a reference CQI, (e.g., the CQI of frequency-unit (x), and/or CQI(x)), where ψ is an integer denoting the index of a frequency-unit.

In examples, at a given time-unit, the WTRU may determine a differential CQI at a frequency-unit (x+1), relative to the CQI at frequency-unit x as follows in Equation (9):

$$Differential\_CQI ( x + 1 ) = CQI ( x ) - CQI ( x + 1 ) \qquad Equation ( 9 )$$

If one or more Differential_CQI, (e.g., Differential_CQI(x+1) is less than a threshold(s), the WTRU may determine one CQI, (e.g., CQI(x), or Dfferential_CQI(x), CQI(x+1), min (CQI(x), CQI(x+1), max (CQI(x), CQI(x+1)), and/or average of CQI(x) and CQI(x+1). The WTRU may assume that the determined CQI is applicable to a frequency-units (x+1, x+2, . . . , x+w).

In another example, at a given frequency-unit, the WTRU may determine a differential CQI at a time-unit (y+1) relative to the CQI at time-unit (y+1) as follows in Equation (10):

$$Differential\_CQI ( y + 1 ) = CQI ( y ) - CQI ( y + 1 ) \qquad Equation ( 10 )$$

If one or more Differential_CQI, (e.g., Differential_CQI (y+1) is less than a threshold (o), the WTRU may determine one CQI, (e.g., CQI (y), Differential_CQI (y), CQI (y+1), min (CQI (y), CQI (y+1)), max (CQI (y), CQI (y+1)), and/or average of CQI (y) and CQI (y+1). The WTRU may assume that the determined CQI is applicable to a time-units (y+1, y+2, . . . , y+ε).

The parameters ζ, σ, ψ and/or ε may be fixed and/or configurable indicated by an implicit and/or explicit indication through a semi-static configuration. The parameters may be jointly and/or separately configurable. The parameters ζ, σ, ψ and/or ε may initially be configured by RRC, however, to control the overhead and reliability of the system. The thresholds ζ, σ, ψ and/or ε may be dynamically updated by a MAC-CE and/or a DCI. The WTRU may also receive an RRC configuration of the parameters ζ, σ, ψ and/or ε as part of an existing RRC configuration. In examples, the WTRU may receive the parameter values ζ, σ, ψ and/or ε as part of the ParamCombination. Additionally or alternatively, the WTRU may determine and/or report a value of the parameters ζ, σ, ψ and/or ε, based on the use-case scenario, WTRU capability, received grant for PUCCH and/or PUSCH, and/or reliability requirement. The WTRU may report a separate indication for each parameter and/or the WTRU may report a single value to report a combination of the parameter values ζ, σ, ψ, and/or ε.

The WTRU may receive an RRC, DCI, and/or MAC-CE configuration of the CQI reporting method. Additionally or alternatively, the WTRU may indicate its preferred reporting method based on the determined differential CQIs.

The WTRU may use any one or more of a plurality of methods for reporting CQIs with smaller feedback overhead. In examples, the WTRU may report, for each of the N_4 time-units, one wideband CQI for all N_3 frequency units and/or N_3 Vψ sub-band CQIs for the N_3 frequency-units. In other examples, the WTRU may report, for each of the N_4 Vχ time-units, one wideband CQI for all N_3 frequency-units and/or N_3 Vψ sub-band CQIs for the N_3 frequency-units. Further, in other examples, the WTRU may report, for each of the N_4 Vχ time-units, one wideband CQI for all N_3 frequency-units and/or one sub-band CQIs for each of the N_3 frequency-units.

What is claimed is:

1.-20. (canceled)

21. A wireless transmit/receive unit (WTRU) comprising a processor and memory, the processor and memory configured to:
receive a downlink (DL) reference signal on a DL channel;
measure a Doppler related parameter value based on the DL reference signal;
estimate one or more time domain channel properties (TDCPs) of the DL channel associated with one or more delays, wherein the one or more estimated TDCPs are based on the measured Doppler related parameter value;
determine a confidence level for the one or more estimated TDCPs based on one or more of channel conditions, WTRU architecture, receive antenna configuration information, channel state information (CSI) reporting configuration, or system configuration; and
send a report that indicates the one or more estimated TDCPs and the confidence level for the one or more estimated TDCPs.

22. The WTRU of claim 21, further configured to:
determine whether the confidence level is below a pre-configured threshold, wherein the report indicates a null value for the one or more estimated TDCPs when the confidence level is below the pre-configured threshold.

23. The WTRU of claim 21, wherein the one or more TDCPs comprise a non-quantized TDCP, the WTRU further configured to quantize the non-quantized TDCP.

24. The WTRU of claim 21, wherein the confidence level is determined by comparing the estimated one or more TDCPs with a measured TDCP.

25. The WTRU of claim 21, wherein the one or more delays comprise a maximum delay that satisfies a preconfigured time threshold.

26. The WTRU of claim 21, wherein the report is a CSI report and is transmitted with a higher priority as compared to other CSI reports

27. The WTRU of claim 21, wherein the confidence level comprises an indication of a prediction accuracy of the CSI associated with a future time slot.

28. The WTRU of claim 21, wherein the Doppler related parameter value is a Doppler shift, a Doppler spread, or a time domain channel correlation.

29. The WTRU of claim 21, wherein the one or more estimated TDCP comprise one or more of a Doppler shift, a Doppler spread, or a time domain channel correlation.

30. The WTRU of claim 21, wherein the WTRU may assign one or more of an amplitude value or a phase value to the one or more estimated TDCPs.

31. A method performed by a wireless transmit/receive unit (WTRU), the method comprising:
receiving a downlink (DL) reference signal on a DL channel;
measuring a Doppler related parameter value based on the DL reference signal;
estimating one or more time domain channel properties (TDCPs) of the DL channel associated with one or more delays, wherein the one or more estimated TDCPs are based on the measured Doppler related parameter value;
determining a confidence level for the one or more estimated TDCPs based on one or more of channel conditions, WTRU architecture, receive antenna configuration information, channel state information (CSI) reporting configuration, or system configuration; and
sending a report that indicates the one or more estimated TDCPs and the confidence level for the one or more estimated TDCPs.

32. The method of claim 31, further comprising:
determining whether the confidence level is below a pre-configured threshold, wherein the estimated TDCP is a null report when the confidence level is below the pre-configured threshold.

33. The method of claim 31, wherein the one or more estimated TDCP comprise a non-quantized TDCP, the WTRU further configured to quantize the non-quantized TDCP.

34. The method of claim 31, wherein the confidence level is determined by comparing the one or more estimated TDCPs with a measured TDCP.

35. The method of claim 31, wherein the one or more delays comprise a maximum delay that satisfies a preconfigured time threshold.

36. The method of claim 31, wherein the report is a CSI report and is transmitted with a higher priority as compared to other CSI reports.

37. The method of claim 31, wherein the confidence level comprises an indication of a prediction accuracy of the CSI associated with a future time slot.

38. The method of claim 31, wherein the Doppler related parameter value is one of a Doppler shift, a Doppler spread, or a time domain channel correlation.

39. The method of claim 31, wherein the one or more estimated TDCPs comprise one or more of a Doppler shift, a Doppler spread, or a time domain channel correlation.

40. The method of claim 31, wherein the WTRU may assign one or more of an amplitude value or a phase value to the one or more estimated TDCPs.
